(19) United States
(12) Patent Application Publication
(10) Pub. No.: US 2026/0040372 A1
(43) Pub. Date: Feb. 5, 2026

(54) APPARATUS AND METHOD FOR LOCATION TRIGGERED SECURE DATA TRANSACTION BASED ON DEVICE-TO-DEVICE COMMUNICATIONS

(71) Applicant: QUALCOMM Incorporated, San Diego, CA (US)

(72) Inventors: Archana SHRIVASTAVA, San Diego, CA (US); Shenbo YU, Andover, MA (US); Mandyam VIKRAM, San Diego, CA (US); Ketal GANDHI, San Diego, CA (US); Samuel HALL, Littleton, CO (US); Atul PRASAD, Washington, DC (US); Nimish SHRIVASTAVA, San Marcos, CA (US)

(21) Appl. No.: 18/795,057

(22) Filed: Aug. 5, 2024

(51) Int. Cl. H04W 76/10; H04W 12/06; H04W 12/63

(52) U.S. Cl. CPC H04W 76/10; H04W 12/06; H04W 12/63

(57) ABSTRACT

Disclosed are techniques for wireless communication. In an aspect, a user device may establish a device-to-device communication with a point of interaction (POI) device based on a distance between the user device and the POI device being within a reference distance. The user device may engage in an authentication procedure with the POI device via the device-to-device communication to verify authenticity of the POI device. The user device may send transaction data to the POI device via the device-to-device communication after the authenticity of the POI device is verified. The user device may terminate the device-to-device communication after the transaction data is sent to the POI device.

### BACKGROUND OF THE DISCLOSURE

### 1. Field of the Disclosure

Aspects of the disclosure relate generally to a system for a secure data transaction (e.g., usable in a payment process) based on wireless technologies.

### 2. Description of the Related Art

Various payment systems have been developed to provide in-store payment services or in-vehicle payment services. In some applications, an in-store credit card payment system may require a user to be in close proximity to a payment terminal. As the payment terminal may be expensive to acquire and/or maintain, the number of the payment terminals in a store may be limited, and the user may need to stand in a queue in order to obtain access to the payment terminal. Waiting in a queue can result in frustration of customers and potentially losing customers if not managed properly.

In some applications, an image-based payment system (e.g., based on scanning a barcode or a two-dimensional data code) may also be used for in-store transactions. Making a payment based on the image-based payment system may include using a user device to scan a barcode or a two-dimensional data code provided by the store. In some applications, the barcode or the two-dimensional data code may be altered without proper authorization or authentication. If the barcode or the two-dimensional data code is malicious, accessing a link or executing an instruction provided by the scanned code may also enable hackers to steal a user's personal financial information.

In some applications, an in-vehicle payment system may be implemented based on integrating a wallet service into an infotainment system of a vehicle. Such wallet service may be based on a processing device onboard the vehicle communicating with a parking terminal, an electric vehicle charging station, and/or a drive-through payment terminal of a store through a network and/or cloud computing. In some examples, the payment processed by the in-vehicle payment system may be considered as a card-not-present transaction and may be subject to greater risks than card-present transactions.

Accordingly, there may be a need for a system for a secure data transaction (e.g., usable in a payment process) with improved convenience and improved security.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user device includes establishing a device-to-device communication with a point of interaction (POI) device based on a distance between the user device and the POI device being within a reference distance; engaging in an authentication procedure with the POI device via the device-to-device communication to verify authenticity of the POI device; sending transaction data to the POI device via the device-to-device communication after the authenticity of the POI device is verified; and terminating the device-to-device communication after the transaction data is sent to the POI device.

In an aspect, a user device includes one or more memories; one or more transceivers; and one or more processors communicatively coupled to the one or more memories and the one or more transceivers, the one or more processors, either alone or in combination, configured to: establish a device-to-device communication with a point of interaction (POI) device based on a distance between the user device and the POI device being within a reference distance; engage in an authentication procedure with the POI device via the device-to-device communication to verify authenticity of the POI device; send, via the one or more transceivers, transaction data to the POI device via the device-to-device communication after the authenticity of the POI device is verified; and terminate the device-to-device communication after the transaction data is sent to the POI device.

In an aspect, a user device includes means for establishing a device-to-device communication with a point of interaction (POI) device based on a distance between the user device and the POI device being within a reference distance; means for engaging in an authentication procedure with the POI device via the device-to-device communication to verify authenticity of the POI device; means for sending transaction data to the POI device via the device-to-device communication after the authenticity of the POI device is verified; and means for terminating the device-to-device communication after the transaction data is sent to the POI device.

In an aspect, a non-transitory computer-readable medium stores computer-executable instructions that, when executed by a user device, cause the user device to: establish a device-to-device communication with a point of interaction (POI) device based on a distance between the user device and the POI device being within a reference distance; engage in an authentication procedure with the POI device via the device-to-device communication to verify authenticity of the POI device; send transaction data to the POI device via the device-to-device communication after the authenticity of the POI device is verified; and terminate the device-to-device communication after the transaction data is sent to the POI device.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example environment for a secure data transaction, according to aspects of the disclosure.

FIG. 2 illustrates an example processing device architecture, according to various aspects of the disclosure.

FIG. 3A is a block diagram illustrating a first example system configuration, according to aspects of the disclosure.

FIG. 3B is a block diagram illustrating a second example system configuration, according to aspects of the disclosure.

FIGS. 4A and 4B show a diagram illustrating a first example process flow for a secure data transaction, according to aspects of the disclosure.

FIGS. 4C and 4D show a diagram illustrating a second example process flow for a secure data transaction, according to aspects of the disclosure.

FIG. 5 shows a diagram illustrating an example process flow for determining a location of a user device, according to aspects of the disclosure.

FIG. 6 shows a diagram illustrating an example process flow for provisioning a user device, according to aspects of the disclosure.

FIG. 7 shows a diagram illustrating an example process flow for provisioning a point of interaction (POI) device, according to aspects of the disclosure.

FIG. 8 shows a diagram illustrating an example process flow for a mutual authentication procedure, according to aspects of the disclosure.

FIG. 9 shows a diagram illustrating an example processing sequence of a device-to-device (D2D) service of a consumer software development kit (SDK), according to aspects of the disclosure.

FIG. 10 shows a diagram illustrating an example process flow for proximity operation sequences by a user device, according to aspects of the disclosure.

FIG. 11 shows a diagram illustrating an example process flow for advertisement sequences by a POI device, according to aspects of the disclosure.

FIG. 12 illustrates a method of wireless communication performed by a user device, according to aspects of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to a system and a method for a secure data transaction (e.g., usable in a payment process) based on wireless technologies.

Particular aspects of the subject matter described in this disclosure can be implemented to realize one or more of the following potential advantages. For example, the subject matter may correspond to triggering a secure data transaction using a device-to-device (D2D) communication between a user device and a point of interaction (POI) device (e.g., a payment terminal device) based on determining that the user device is in close proximity to the POI device. In some aspects, the POI device described in this disclosure may be a stationary device, a portable device, or another user device (e.g., held by a user or disposed on a vehicle).

In some aspects, the user device and the POI device may correspond to two moving devices (e.g., two moving vehicles) for data sharing, two users for payment within certain proximity for a transaction based on software point of sales (Softpos) technology, or the like. In one example, a moving passenger vehicle can connect to a moving fuel truck within certain distance to make an advance payment for fuel to be delivered to the passenger vehicle at a later time at a mutually agreed upon location. In another example, autonomous trucks that are part of platooning (i.e., driving together with a lead truck) can make payment for all the platooned trucks as they pass the tolling plaza.

In some examples, the proximity location based triggering as illustrated in this disclosure may provide an additional layer of security (based on the proximity and authentication between the devices) for the secure data transaction, while the D2D communication may still allow a secure short-range or mid-range communication. Accordingly, a secure data transaction (e.g., for a payment process) between the user device and the POI device may be performed with improved security and convenience of the users.

In some aspects, many examples in the disclosure may be illustrated based on implementing a payment process. In some aspects, the secure data transaction between two devices as illustrated in this disclosure may be applicable to many different applications or services, such as banking, access control (e.g., visitor management, employee access, event access), personalized advertisement, content sharing, vehicle-to-everything (V2X) communication, public safety and emergency services (e.g., communications among first responders, polices, patients, and/or firefighters), social networking, device-based relaying, proximity based utility meter reading, or the like.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

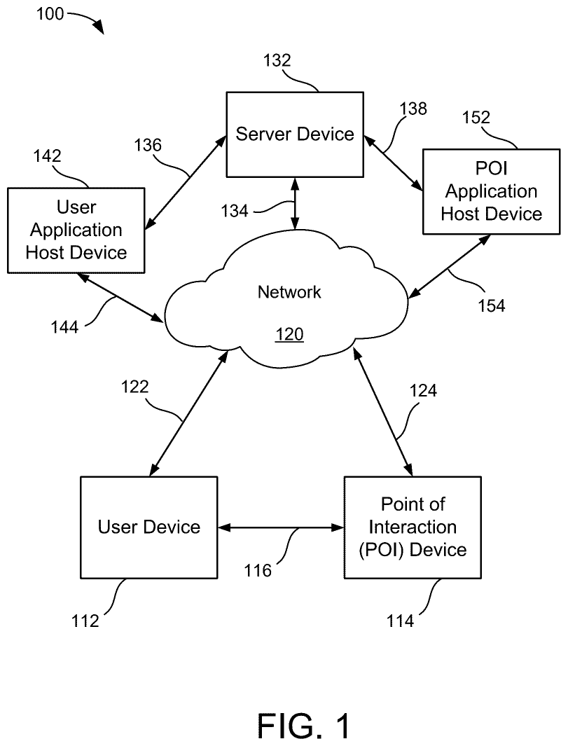

FIG. 1 illustrates an example environment 100 for a secure data transaction, according to aspects of the disclosure. In some aspects, various devices or components in the environment 100 may be configured to communicate based on wired communication systems and/or wireless communication systems.

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

Moreover, a fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RSP), such as downlink, uplink, or sidelink positioning reference signals (PRS)), and other technical enhancements.

Also, there are other wireless communication systems developed for communications with an effective range shorter than that of the aforementioned wireless communication systems (e.g., LTE, WiMax, or 5G). The other wireless communication systems for short-range communications may be based on a radio access technology (RAT) such as WiFi, LTE-D, Bluetooth®, Zigbee®, Z-Wave®, sidelink (e.g., PC5 interface) based on LTE or 5G, dedicated short-range communications (DSRC), wireless access for vehicular environments (WAVE), near-field communication (NFC), ultra-wideband (UWB), Bluetooth® low energy (BLE), etc. In some aspects, these other wireless communication systems for short-range communications may be designed to provide data communications as well as positioning or ranging services.

As shown in FIG. 1, the environment 100 may include a user device 112 and a point of interaction (POI) device 114. In some aspects, the user device 112 may be a mobile device, a user equipment (UE), or a processing device onboard a vehicle. In some aspects, the POI device 114 may be an internet of things (IoT) device or a payment terminal device. In some aspects, the POI device 114 may be a stationary device, a portable device, or another user device (e.g., held by a user or disposed on a vehicle). In some aspects, the user device 112 and the POI device 114 may be configured to communicate with each other via device-to-device (D2D) communications 116 based on any short-range, mi-range, and/or long-range communication technologies (e.g., sidelink, WiFi, UWB, NFC, Bluetooth®, BLE, or the like). In some aspects, the user device 112 may be communicatively coupled to a network 120 via communications 122 based on a wireless communication technology, such as any of the wireless communication technologies discussed above. In some aspects, the POI device 114 may be communicatively coupled to the network 120 via communications 124 based on a wired communication technology or a wireless communication technology.

As shown in FIG. 1, the environment 100 may include a server device 132 that may be communicatively coupled to the network 120 via communications 134 based on a wired communication technology or a wireless communication technology. The environment 100 may include a user application host device 142 that may be communicatively coupled to the network 120 via communications 144 based on a wired communication technology or a wireless communication technology. The environment 100 may include a POI application host device 152 that may be communicatively coupled to the network 120 via communications 154 based on a wired communication technology or a wireless communication technology. In some aspects, the server device 132 may be, in addition to or in place of passing through the network 120, communicatively coupled to the user application host device 142 via communications 136 based on a wired communication technology or a wireless communication technology. In some aspects, the server device 132 may be, in addition to or in place of passing through the network 120, communicatively coupled to the POI application host device 152 via communications 138 based on a wired communication technology or a wireless communication technology.

In some aspects, the environment 100 is depicted as a simplified, non-limiting example. In some aspects, some components may be simplified or not depicted in FIG. 1. For example, in some aspects, the server device 132 may be implemented as one or more physical devices. In some aspects, the user application host device 142 may implemented as one or more physical devices or may be, in whole or in part, incorporated into the server device 132. In some aspects, the POI application host device 152 may implemented as one or more physical devices or may be, in whole or in part, incorporated into the server device 132.

In some aspects, the user device 112 may engage in a secure data transaction session with the POI device 114 in order to send transaction data to the POI device 114. In some aspects, the user device 112 may engage in the secure data transaction session based on operating an application obtained from and/or managed by the user application host device 142. In some aspects, the transaction data may be sent to the POI device 114 based on the device-to-device communications 116, or the POI device 114 scanning a visual image (e.g., a barcode or a two-dimensional data code) displayed by the user device 112, or a combination thereof. In some aspects, the POI device 114 may engage in the secure data transaction session based on operating an application obtained from and/or managed by the POI application host device 152. In some aspects, the transaction data may be forwarded to the server device 132 for further processing and/or verification.

In some aspects, the environment 100 may be used to allow the user device 112 to make a payment to the POI device 114 based on the transaction data sent using the secure data transaction session. In some aspects, the environment 100 may correspond to an implementation example of a contactless payment system or a touchless payment system.

In some aspects, in order to better identifying and/or preventing possible fraudulent activities, a payment system as discussed in this disclosure may be based on indoor location data of the user device 112 (e.g., obtained based on a positioning service according to the example wireless communication systems discussed above). In some aspects, geolocation data of the user device 112 based on a global navigation satellite system (GNSS) may not be sufficiently accurate for indoor shopping. In some aspects, making a payment using a payment system as discussed in this disclosure may be based on a secure data transaction session triggered by the indoor location data of the user device 112 satisfying certain criteria. In some aspects, NFC may be used when the user device 112 is very close to the POI device 114, but NFC may not be capable of providing more secure data communications.

In some aspects, various embodiments described in this disclosure may correspond to initiating the data transaction and/or device authentications based on the indoor location information of the user device 112 indicating that the user device 112 is in close proximity to the POI device 114. In some aspects, various embodiments described in this disclosure may provide proximity detection at the user device 116 for automated processing to increase convenience for the users. In some aspects, the payload data from the POT device 114 may also be used for determining the location of the user device 112.

In some aspects, the user device 112 and the POI device 114 may establish D2D communications 116 based on communication technologies such as BLE, UWB, or sidelink communication for a secure data transaction. In some aspects, a cryptographic method with a mutual authentication procedure may be applied to avoid vulnerabilities such as spoofing, eavesdropping, jamming, and/or relay attacks. In some aspects, the POI device 114 may send encrypted advertisements with hardware keys, which may be provisioned and/or rotated by the server device 132 (e.g., as a cloud service). In some aspects, the user device 112 and the POI device 114 may undergo periodic attestation using an attestation microservice to enhance fraud protection.

In some aspects, the D2D communications 116 according to this disclosure may correspond to short-range, mid-range, or long-range communications such that the user of the user device 112 may engage in the secure data transaction session without staying in a long queue. In some aspects, multiple user devices may communicate with one POI device or engage in peer-to-peer communications.

In some aspects, the POI device 114 according to this disclosure may integrate other types of payment system, such as an image-based payment system (e.g., based on scanning a barcode or a two-dimensional data code), to further enhance security and/or reduce overall costs.

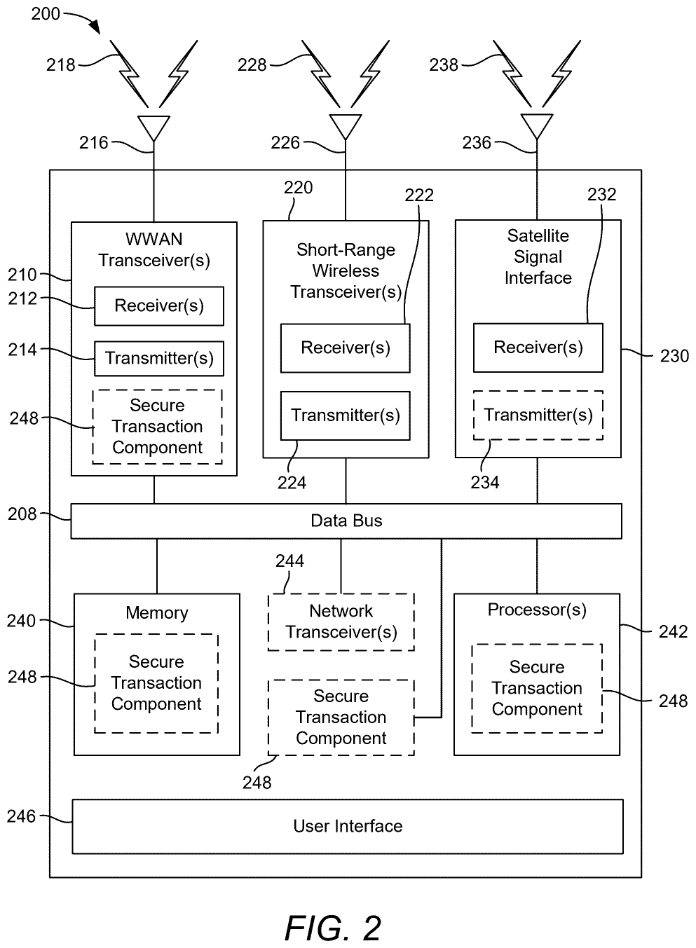

FIG. 2 illustrates several example components (represented by corresponding blocks) that may be incorporated into a processing device 200 (which may correspond to the user device 112 or the POI device 114 described herein). It will be appreciated that these components may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The processing device 200 includes one or more wireless wide area network (WWAN) transceivers 210 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 210 may each be connected to one or more antennas 216 for communicating with other network nodes, such as other processing devices, UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 210 may be variously configured for transmitting and encoding signals 218 (e.g., messages, indications, information, and so on) and, conversely, for receiving and decoding signals 218 (e.g., messages, indications, information, pilots, and so on) in accordance with the designated RAT. Specifically, the one or more WWAN transceivers 210 include one or more transmitters 214 for transmitting and encoding signals 218 and one or more receivers 212 for receiving and decoding signals 218.

The processing device 200 also includes, at least in some cases, one or more short-range wireless transceivers 220. The one or more short-range wireless transceivers 220 may be connected to one or more antennas 226 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, BLUETOOTH®, ZIGBEE®, Z-WAVE®, PC5, dedicated short-range communications (DSRC), wireless access for vehicular environments (WAVE), NFC, UWB, etc.) over a wireless communication medium of interest. The one or more short-range wireless transceivers 220 may be variously configured for transmitting and encoding signals 228 (e.g., messages, indications, information, and so on) and, conversely, for receiving and decoding signals 228 (e.g., messages, indications, information, pilots, and so on) in accordance with the designated RAT. Specifically, the one or more short-range wireless transceivers 220 include one or more transmitters 224 for transmitting and encoding signals 228 and one or more receivers 222 for receiving and decoding signals 228. As specific examples, the one or more short-range wireless transceivers 220 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The processing device 200 also includes, at least in some cases, a satellite signal interface 230, which includes one or more satellite signal receivers 232 and may optionally include one or more satellite signal transmitters 234. The one or more satellite signal receivers 232 may be connected to one or more antennas 236 and may provide means for receiving and/or measuring satellite positioning/communication signals 238. Where the one or more satellite signal receivers 232 include a satellite positioning system receiver, the satellite positioning/communication signals 238 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 232 include a non-terrestrial network (NTN) receiver, the satellite positioning/communication signals 238 may be communication signals (e.g., carrying control and/or user data) originating from a 5G network. The one or more satellite signal receivers 232 may comprise any suitable hardware and/or software for receiving and processing satellite positioning/communication signals 238. The one or more satellite signal receivers 232 may request information and operations as appropriate from the other systems, and, at least in some cases, perform calculations to determine locations of the processing device 200 using measurements obtained by any suitable satellite positioning system algorithm.

The optional satellite signal transmitter(s) 234, when present, may be connected to the one or more antennas 236 and may provide means for transmitting satellite positioning/communication signals 238. Where the one or more satellite signal transmitters 234 include an NTN transmitter, the satellite positioning/communication signals 238 may be communication signals (e.g., carrying control and/or user data) originating from a 5G network. The one or more satellite signal transmitters 234 may comprise any suitable hardware and/or software for transmitting satellite positioning/communication signals 238. The one or more satellite signal transmitters 234 may request information and operations as appropriate from the other systems.

The processing device 200 may include one or more network transceivers 244, providing means for communicating (e.g., means for transmitting, means for receiving, etc.) with other entities. For example, the processing device 200 may employ the one or more network transceivers 244 to communicate with other processing devices over one or more wired or wireless links.

A transceiver may be configured to communicate over a wired or wireless link. A transceiver (whether a wired transceiver or a wireless transceiver) includes transmitter circuitry (e.g., transmitters 214, 224) and receiver circuitry (e.g., receivers 212, 222). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 214, 224) may include or be coupled to a plurality of antennas (e.g., antennas 216, 226), such as an antenna array, that permits the respective apparatus (e.g., processing device 200) to perform transmit “beamforming,” as described herein. Similarly, wireless receiver circuitry (e.g., receivers 212, 222) may include or be coupled to a plurality of antennas (e.g., antennas 216, 226), such as an antenna array, that permits the respective apparatus (e.g., processing device 200) to perform receive beamforming, as described herein. In an aspect, the transmitter circuitry and receiver circuitry may share the same plurality of antennas (e.g., antennas 216, 226), such that the respective apparatus can only receive or transmit at a given time, not both at the same time. A wireless transceiver (e.g., the one or more WWAN transceivers 210, the one or more short-range wireless transceivers 220) may also include a network listen module (NLM) or the like for performing various measurements.

As used herein, the various wireless transceivers (e.g., transceivers 210 and 220, and network transceivers 244 in some implementations) and wired transceivers (e.g., network transceivers 244 in some implementations) may generally be characterized as “a transceiver,” “at least one transceiver,” or “one or more transceivers.” As such, whether a particular transceiver is a wired or wireless transceiver may be inferred from the type of communication performed.

The processing device 200 also includes other components that may be used in conjunction with the operations as disclosed herein. The processing device 200 includes one or more processors 242 for providing functionality relating to, for example, wireless communication, and for providing other processing functionality. The one or more processors 242 may therefore provide means for processing, such as means for determining, means for calculating, means for receiving, means for transmitting, means for indicating, etc. In an aspect, the one or more processors 242 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The processing device 200 includes memory circuitry implementing memory 240 (e.g., each including a memory device) for maintaining information (e.g., information indicative of reserved resources, thresholds, parameters, and so on). The memory 240 may therefore provide means for storing, means for retrieving, means for maintaining, etc. In some cases, the processing device 200 may include a secure transaction component 248. The secure transaction component 248 may be hardware circuits that are part of or coupled to the one or more processors 242 that, when executed, cause the processing device 200 to perform the functionality described herein. In other aspects, the secure transaction component 248 may be external to the processors 242 (e.g., part of a modem processing system, integrated with another processing system, etc.). Alternatively, the secure transaction component 248 may be a memory module stored in the memory 240 that, when executed by the one or more processors 242 (or a modem processing system, another processing system, etc.), cause the processing device 200 to perform the functionality described herein. FIG. 2 illustrates possible locations of the secure transaction component 248, which may be, for example, part of the one or more WWAN transceivers 210, the memory 240, the one or more processors 242, or any combination thereof, or may be a standalone component.

The various components of the processing device 200 may be communicatively coupled to each other over a data bus 208. In an aspect, the data bus 208 may form, or be part of, a communication interface of the processing device 200.

In addition, the processing device 200 may include a user interface 246 providing means for providing indications (e.g., audible and/or visual indications) to a user and/or for receiving user input (e.g., upon user actuation of a sensing device such a keypad, a touch screen, a microphone, and so on).

For convenience, the processing device 200 is shown in FIG. 2 as including various components that may be configured according to the various examples described herein. It will be appreciated, however, that the illustrated components may have different functionality in different designs. In particular, various components in FIG. 2 are optional in alternative configurations and the various aspects include configurations that may vary due to design choice, costs, use of the device, or other considerations. In one example, a particular implementation of processing device 200 configured as a user device (e.g., the user device 112) may omit the one or more network transceivers 244, or may omit the satellite signal interface 230, and so on. In another example, a particular implementation of processing device 200 configured as a POI device (e.g., the POI device 114) may omit the WWAN transceiver(s) 210, or may omit the satellite signal interface 230, and so on. For brevity, illustration of the various alternative configurations is not provided herein, but would be readily understandable to one skilled in the art.

The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 210 to 246 may be implemented by processor and memory component(s) of the processing device 200 (e.g., by execution of appropriate code and/or by appropriate configuration of processor components). For simplicity, various operations, acts, and/or functions are described herein as being performed “by a processing device,” “by a user device,” and/or “by a POI device.” However, as will be appreciated, such operations, acts, and/or functions may actually be performed by specific components or combinations of components of the processing 200, such as the one or more processors 242, the one or more transceivers 210, 220 and/or 244, the memory 240, the secure transaction component 248, etc.

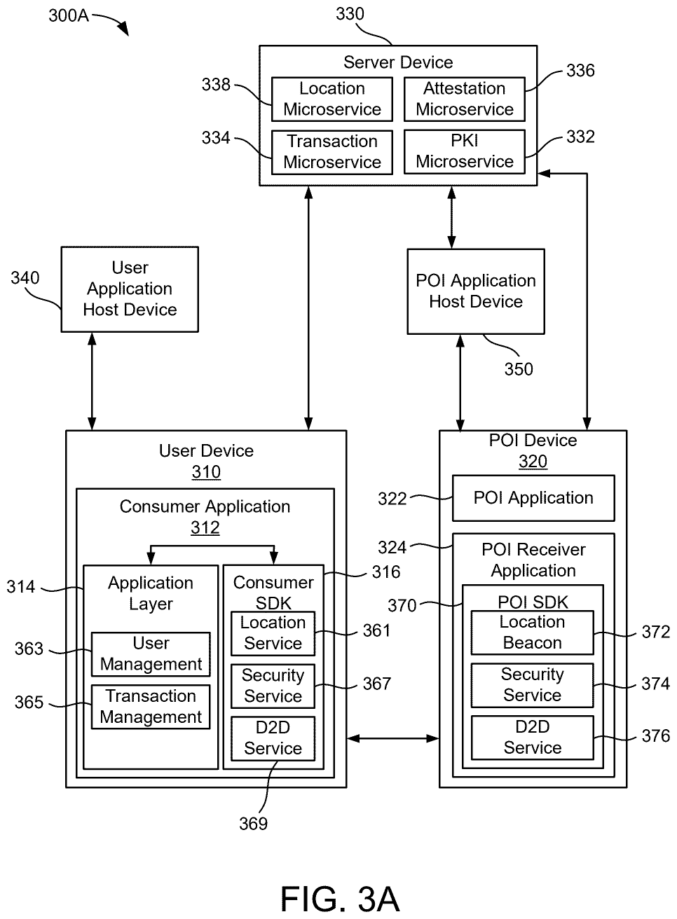

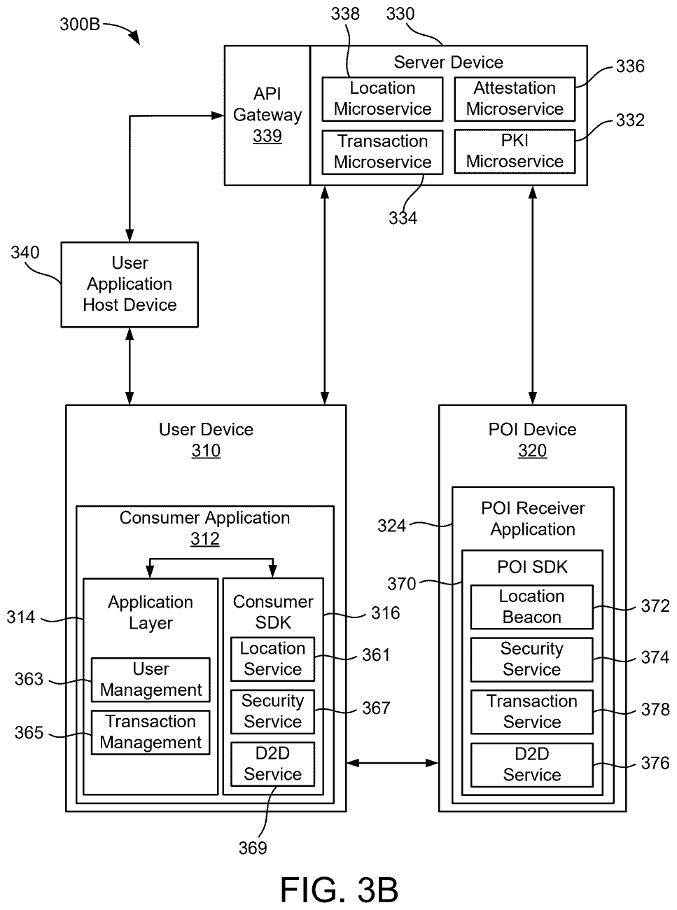

FIG. 3A is a block diagram illustrating a first example system configuration 300A, according to aspects of the disclosure. As shown in FIG. 3A, as a non-limiting example, the system configuration 300A may include a user device 310, a POI device 320, a server device 330, a user application host device 340, and a POI application host device 350. In some aspects, the user device 310 may correspond to the user device 112 in FIG. 1; the POI device 320 may correspond to the POI device 114; the server device 330 may correspond to the server device 132; the user application host device 340 may correspond to the user application host device 142; and the POI application host device 350 may correspond to the POI application host device 152. In some aspects, the server device 330, the user application host device 340, and/or the POI application host device 350, alone or in combination, may be implemented as one or more physical devices providing one or more cloud-based services.

In some aspects, according to the system configuration 300A and as initialization for a secure data transaction session, the POI device 320 may be securely provisioned with certificates for mutual authentication, as well as keys for encrypting transaction data and/or a store-specific profile by a public key infrastructure (PKI) microservice 332 and/or a transaction microservice 334 provided by the server device 330.

In some aspects, according to the system configuration 300A and as initialization for the secure data transaction session, the user device 310 may start a consumer application 312 (including the components configured in the application layer 314 and based on a consumer software development kit (SDK) 316). In some aspects, the consumer application 312 may be obtained from and/or executed in conjunction with the user application host device 340. In some aspects, according to the system configuration 300A and as initialization for the secure data transaction session, the POI device 320 may execute a POI application 322 and a POI receiver application 324 (including the components configured based on a POI SDK 370). In some aspects, the POI application 322 may be obtained from and/or executed in conjunction with the POI application host device 350. In some aspects, the consumer SDK 316 and the POI SDK 370 may be used to interact with the server device 330. In some aspects, the application layer 314 and the POI application 322 may be configured to interact with the server device 330 indirectly through the consumer SDK 316 and the POI SDK 370.

In some aspects, as initialization for the secure data transaction session, the user device 310 may be attested based on an attestation microservice 336 provided by the server device 330. In some aspects, the user device 310, based on a location service 361 provided by the consumer SDK 316, may start monitoring geofences associated with locations of interest (e.g., stores in an area where the user device 310 is located).

In some aspects, the secure data transaction session may start based on the user device 310 moving toward and entering a geofence (e.g., as carried by a user moving toward an associated location of interest, such as a store). After the user device 310 enters the geofence (e.g., a store-level geofence of the store), in order to determine a finer location of the user device 310, the user device 310 may initiate scanning of signals for discovering one or more POI devices disposed at the location of interest (e.g., in the store) and/or positioning reference signals from the one or more POI devices based on e.g., the location service 361 of the consumer SDK 316. In some aspects, in order to determine the finer location, the user device 310 may obtain location assistance data based on the location information regarding the geofence (e.g., the store) from a location microservice 338 provided by the server device 330.

In some aspects, the user device 310 may keep monitoring if a distance between the user device 310 and any of the POI device(s) disposed at the location of interest (e.g., the POI device 320) is within a reference distance (e.g., within 1 meter (m) from the POI device 320, or also referred to as being in close proximity to the POI device 320). In some aspects, whether the user device 310 is in close proximity to the POI device 320 may be monitored by the location service 361 of the consumer SDK 316 monitoring signals transmitted by the POI device 320 based on a location beacon service 372 provided by the POI SDK 370. In some aspects, whether the user device 310 is within the reference distance from the POI device 320 may be determined based on the finer location of the user device 310, or alternatively based on the user device 310 measuring a time of flight, time of arrival, or signal strength of reference signals from the POI device 320 without using the finer location. In such scenario, the reference distance may be indirectly tunable based on adjusting a power level of the reference signals from the POI device 320.

In some aspects, based on determining that the user device 310 is within the reference distance from the POI device 320, the location service 361 of the consumer SDK 316 may send a POI entry message to the application layer 314 notifying a user management 363 of the application layer 314 that the user device 310 is in close proximity to the POI device 320, together with related information such as an identifier of the POI device 320, a location of the user device 310, and/or a zone in which the user device is located. After receiving the POI entry message, the user management 363 of the application layer 314 and/or a transaction management 365 of the application layer 314 may forward user data and/or transaction data to the consumer SDK 316 (e.g., to a security service 367 of the consumer SDK 316 and/or a D2D service 369 of the consumer SDK 316) based on one or more use cases. In some aspects, the security service 367 may encrypt the transaction data to obtain encrypted transaction data.

In some aspects, the user device 310 may establish a D2D communication with the POI device 320 (e.g., based on a D2D service 369 of the consumer SDK 316 and a D2D service 376 of the POI SDK 370). In some aspects, the D2D communication may be based on BLE technology, UWB technology, WLAN technology, or sidelink communication technology (e.g., sidelink based on LTE or 5G). In some aspects, the D2D communication may established based on the user device 310 scanning and obtaining information from radio signals broadcasted by the POI device 320 for discovery.

In some aspects, after the D2D communication is established between the user device 310 and the POI device 320, the user device 310 may engage in an authentication procedure with the POI device 320 via the D2D communication to verify authenticity of the POI device 320 (e.g., based on the security service 367 of the consumer SDK 316 and a security service 374 of the POI SDK 370). In some aspects, after the D2D communication is established between the user device 310 and the POI device 320, the POI device 320 may engage in an authentication procedure with the user device 310 via the D2D communication to verify authenticity of the user device 310 (e.g., based on the security service 367 of the consumer SDK 316 and the security service 374 of the POI SDK 370). In some aspects, the authentication procedure may be a mutual authentication procedure based on exchange of encrypted authentication information between the user device 310 and the POI device 320.

In some aspects, the user device 310 may initiate a secure data transaction (e.g., for a payment process) using the secure data transaction session. For example, the transaction management 365 of the application layer 314 may generate a transaction identifier and send the transaction identifier to the POI device 320 via the D2D communication to initiate the secure data transaction. In some aspects, the D2D service 369 of the consumer SDK 316 may send the transaction identifier, the user data, and/or the encrypted transaction data to the D2D service 376 of the POI SDK 370. In some aspects, the POI SDK 370 may send the user data, the encrypted transaction data, and/or other data (e.g., location data regarding a location of the user device 310 or other metadata) to the POI application 322. In some aspects, the POI SDK 370 may send an attestation report to the POI application 322.

In some aspects, the POI application 322 may send the attestation report together with the user data and/or the encrypted transaction data to the POI application host device 350 for processing. In some aspects, the POI application host device 350 may send the attestation report together with the user data and/or the encrypted transaction data to the server device 330 for processing. In some aspects, the server device 330 may validate the integrity of the encrypted transaction data, and may decrypt the encrypted transaction data based on the transaction microservice 334. In some aspects, the POI application host device 350 may process the decrypted transaction data, record the transaction, and then send receipt data to the POI device 320, to the user device 310 through the POI device 320 and the D2D communication, and/or to the user device 310 via a secure communication between the POI application host device 350 and the user device 310.

FIG. 3B is a block diagram illustrating a second example system configuration 300B, according to aspects of the disclosure. Components in FIG. 3B that are the same or similar to those in FIG. 3A are given the same reference numbers, and detailed description thereof may be simplified or omitted. Compared to the first example system configuration 300A, the second example system configuration may not include the POI application host device 350; the POI device 320 may not include the POI application 322, the POI SDK 370 may further provide a transaction service 378, and the server device 330 may further include an application programming interface (API) gateway 339. In some aspects, the server device 330 and/or the user application host device 340, alone or in combination, may be implemented as one or more physical devices providing one or more cloud-based services.

In some aspects, the system configuration 300B may perform various operations as initialization for a secure data transaction session in a manner similar to those illustrated with respect to the system configuration 300A. For example, the user device 310 may start a consumer application 312 (including the components configured in the application layer 314 and based on a consumer software development kit (SDK) 316) that may be obtained from and/or executed in conjunction with the user application host device 340. In some aspects, the POI device 320 may execute a POI receiver application 324 (including the components configured based on a POI SDK 370). In some aspects, the consumer SDK 316 and the POI SDK 370 may be used to interact with the server device 330. In some aspects, the application layer 314 may be configured to interact with the server device 330 through the consumer SDK 316. In some aspects, after the user device 310 is attested based on an attestation microservice 336 provided by the server device 330, a location service 361 provided by the consumer SDK 316 may monitor geofences associated with locations of interest (e.g., stores in an area where the user device 310 is located).

In some aspects, the secure data transaction session may start based on the user device 310 moving toward and entering a geofence (e.g., as carried by a user moving toward an associated location of interest, such as a store). After the user device 310 enters the geofence (e.g., a store-level geofence of the store), the user device 310 may determine a finer location as illustrated with respect to the system configuration 300A. In some aspects, the user device 310 may keep monitoring if a distance between the user device 310 and any of the POI device(s) disposed at the location of interest (e.g., the POI device 320) is within a reference distance (e.g., within 1 m from the POI device 320, or also referred to as being in close proximity to the POI device 320). In some aspects, whether the user device 310 is in close proximity to the POI device 320 may be monitored by the location service 361 of the consumer SDK 316 monitoring signals transmitted by the POI device 320 based on a location beacon service 372 provided by the POI SDK 370.

In some aspects, based on determining that the user device 310 is within the reference distance from the POI device 320, the location service 361 of the consumer SDK 316 may send a POI entry message to the application layer 314 notifying a user management 363 of the application layer 314 that the user device 310 is in close proximity to the POI device 320, together with related information such as an identifier of the POI device 320, a location of the user device 310, and/or a zone in which the user device is located. After receiving the POI entry message, the user management 363 of the application layer 314 and/or a transaction management 365 of the application layer 314 may forward user data and/or transaction data to the consumer SDK 316 (e.g., to a security service 367 of the consumer SDK 316 and/or a D2D service 369 of the consumer SDK 316) based on one or more use cases. In some aspects, the security service 367 may encrypt the transaction data to obtain encrypted transaction data.

In some aspects, the user device 310 may establish a D2D communication with the POI device 320 (e.g., based on a D2D service 369 of the consumer SDK 316 and a D2D service 376 of the POI SDK 370). In some aspects, the D2D communication may be based on BLE technology, UWB technology, WLAN technology, or sidelink communication technology (e.g., sidelink based on LTE or 5G). In some aspects, the D2D communication may established based on the user device 310 scanning and obtaining information from radio signals broadcasted by the POI device 320 for discovery.

In some aspects, after the D2D communication is established between the user device 310 and the POI device 320, the user device 310 may engage in an authentication procedure with the POI device 320 via the D2D communication to verify authenticity of the POI device 320 (e.g., based on the security service 367 of the consumer SDK 316 and a security service 374 of the POI SDK 370). In some aspects, after the D2D communication is established between the user device 310 and the POI device 320, the POI device 320 may engage in an authentication procedure with the user device 310 via the D2D communication to verify authenticity of the user device 310 (e.g., based on the security service 367 of the consumer SDK 316 and the security service 374 of the POI SDK 370). In some aspects, the authentication procedure may be a mutual authentication procedure based on exchange of encrypted authentication information between the user device 310 and the POI device 320.

In some aspects, the user device 310 may initiate a secure data transaction (e.g., for a payment process) using the secure data transaction session. For example, the transaction management 365 of the application layer 314 may generate a transaction identifier and send the transaction identifier to the POI device 320 via the D2D communication to initiate the secure data transaction. In some aspects, the D2D service 369 of the consumer SDK 316 may send the transaction identifier, the user data, and/or the encrypted transaction data to the D2D service 376 of the POI SDK 370. In some aspects, the POI SDK 370 may send the user data, the encrypted transaction data, and/or other data (e.g., location data regarding a location of the user device 310 or other metadata) to the server device 330 for processing.

In some aspects, the server device 330 may validate the integrity of the user data and/or the encrypted transaction data, and may decrypt the encrypted transaction data based on the transaction microservice 334. In some aspects, the server device 330 may further process the decrypted transaction data and record the transaction. In some aspects, the server device 330 may send a new transaction message to the user application host device 340 using message webhooks through the API gateway 339. The user application host device 340 may, based on the new transaction message, fetch the processed transaction data from the server device 310 through the API gateway 339. In some aspects, the user application host device 340 may, based on the processed transaction data, send receipt data to the POI device 320 through the server device 330, to the user device 310 through the server device 330, the POI device 320, and the D2D communication, and/or to the user device 310 via a secure communication between the user application host device 340 and the user device 310.

In some aspects, various components in FIGS. 3A and 3B may include additional hardware and/or software level of security measures to reduce the chance that the operations performed thereon may be compromised. In some aspects, one example of the security measures may be based on a trusted execution environment (TEE) technology implemented in one or more chips disposed in the components in FIGS. 3A and 3B.

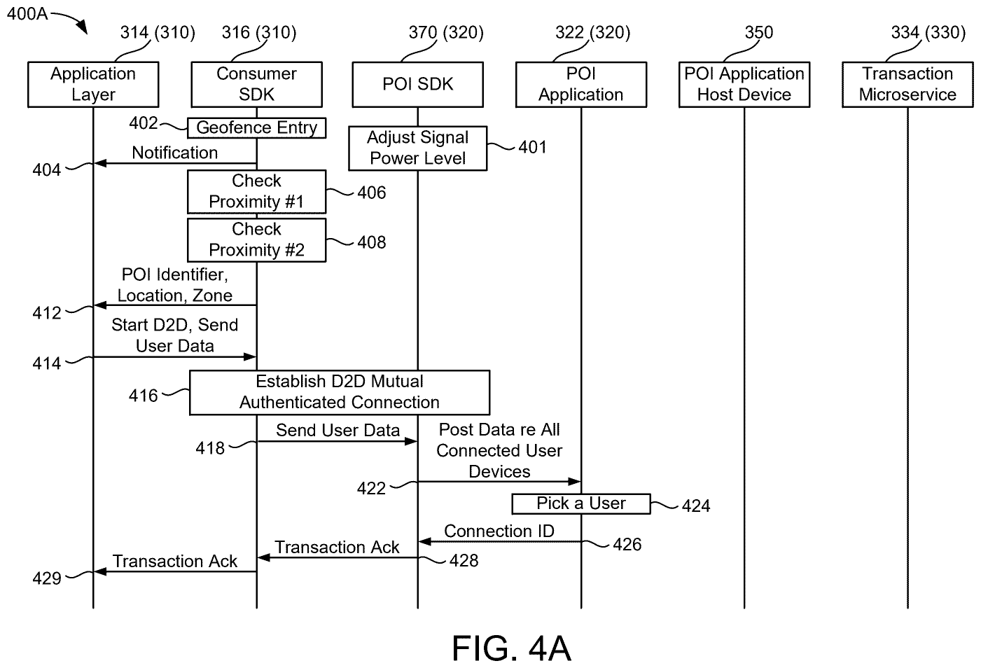

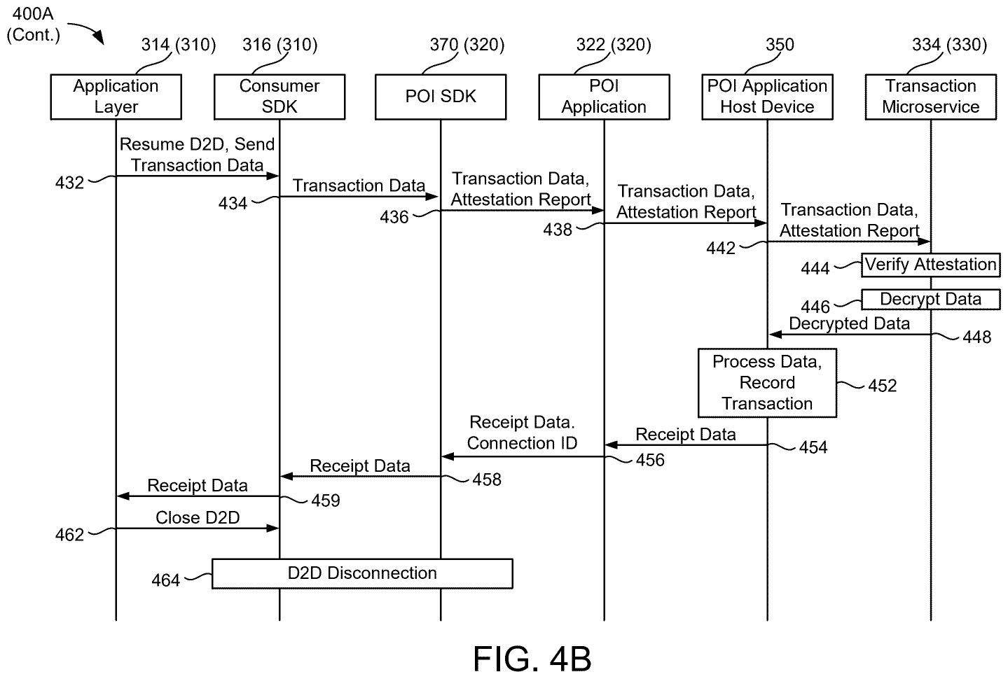

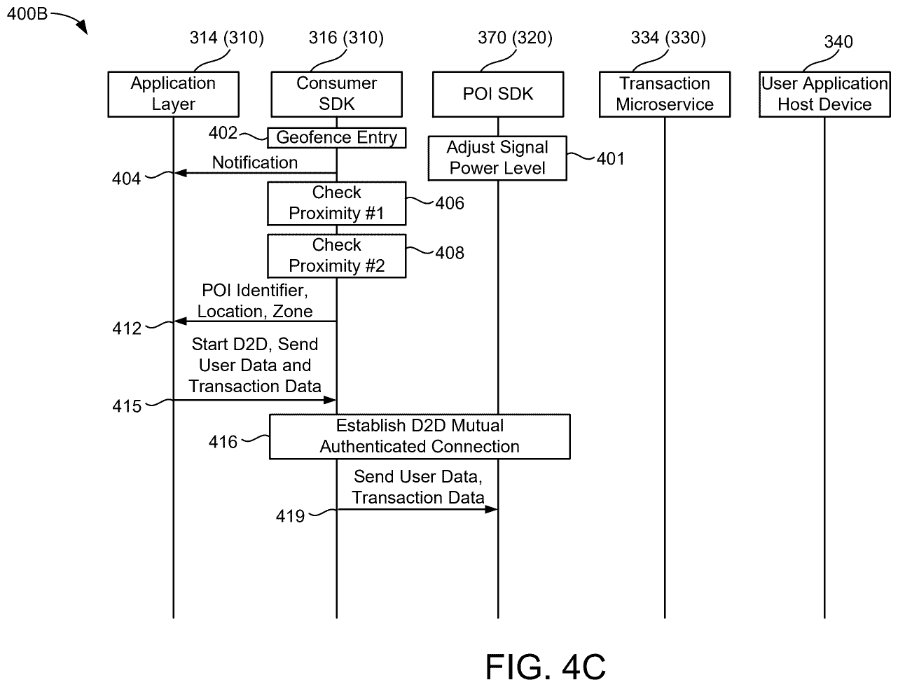

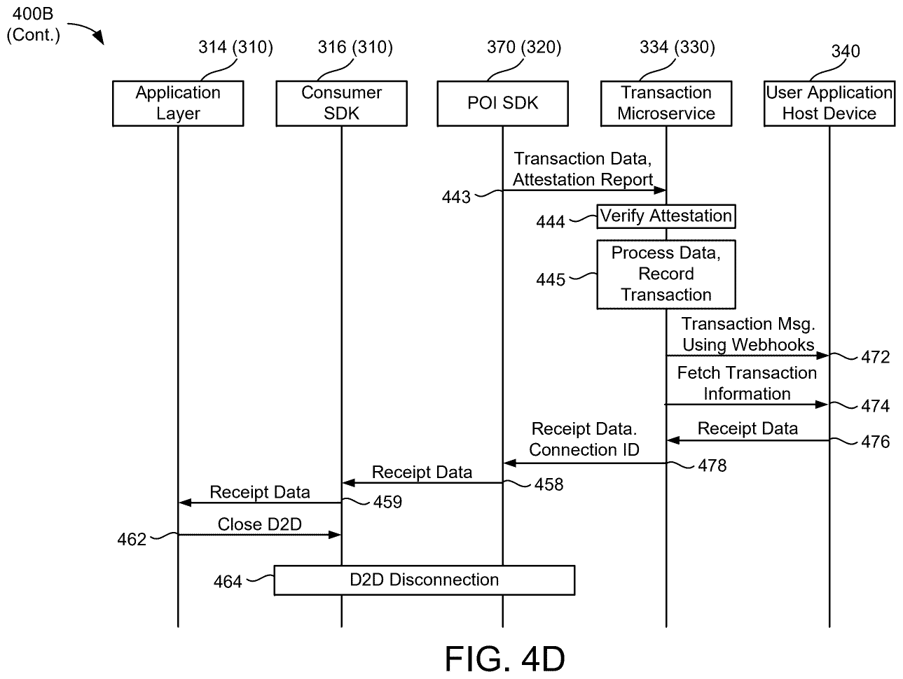

FIGS. 4A and 4B show a diagram illustrating a first example process flow 400A for a secure data transaction, according to aspects of the disclosure. In some aspects, the process flow 400A may correspond to operations performed by the application layer 314, the consumer SDK 316, the POI SDK 370, the POI application 322, the POI application host device 350, and the transaction microservice 334 as shown in FIG. 3A.

In some aspects, the entities for performing various operations are depicted in FIGS. 4A and 4B as a non-limiting example. In some aspects, the operations illustrated as performed by the application layer 314 and the consumer SDK 316 in FIGS. 4A and 4B may be performed by various components of the user device 310; the operations illustrated as performed by the POI SDK 370 and the POI application 322 in FIGS. 4A and 4B may be performed by various components of the POI device 320; and the operations illustrated as performed by the transaction microservice 334 in FIGS. 4A and 4B may be performed by various components of the server device 330.

As shown in FIG. 4A, at stage 401, the POI SDK 370 may adjust a power level of reference signals from the POI device 320. In some aspects, when a distance between the user device 310 and the POI device 320 may be determined based on the user device 310 measuring a time of flight, time of arrival, or signal strength of the reference signals from the POI device 320 without determining a finer location of the user device 310, a reference distance (for stages 406 and 408) may be indirectly tunable based on adjusting the power level of the reference signals from the POI device 320.

In some aspects, at stage 402, the consumer SDK 316 may monitor the location of the user device 310 and determine if the user device 310 has entered a geofence associated with a location of interest (e.g., a store or an area identified as the location of interest). In some aspects, the location of the user device 310 for stage 402 may be obtained based on GNSS, LTE positioning, 5G positioning, or the like. In some aspects, after the consumer SDK 316 determines that the user device 310 has entered the geofence (e.g., of the store or the location of interest), the consumer SDK 316 may send a notification to the application layer 314 at stage 404.

In some aspects, at stage 406 (labeled as “Check Proximity #1”) after the consumer SDK 316 determines that the user device 310 has entered the geofence, the consumer SDK 316 may check if the user device 310 is within a proximity area of at least one POI device of one or more POI devices associated with the location of interest (e.g., disposed in the store as stationary terminals and/or portable terminals, or registered in association with the location of interest). In some aspects, the location of the user device 310 (e.g., an absolute position) for stage 406 may be obtained based on scanning and decrypting payloads carried by beacon signals, advertising signals, or positioning reference signals from one or more POI devices at the location of interest. In some aspects, a distance (e.g., a relative position) of the user device 310 with respect to the POI device 320 may be determined based on the user device 310 measuring a time of flight, time of arrival, or signal strength of the reference signals (e.g., beacon signals, advertising signals, or positioning reference signals) from the POI device 320 without determining the finer location (e.g., an absolute position) of the user device 310.

In some aspects, the beacon signals, advertising signals, or positioning reference signals may be based on BLE, UWB, WLAN, sidelink, or the like. In some aspects, the proximity area may be configured based on an identifier of a POI device in association with the location of the user device 310 (e.g., in the store or registered in association with the location of interest), and may be defined as within a reference radius from the POI device. In some aspects, the reference radius may be 5 m (which may correspond to an equivalent time of flight, time of arrival, or signal strength of the reference signals for a relative position based determination). In some aspects, at stage 406, the consumer SDK 316 may monitor the signals for positioning based on a first monitoring interval. In some aspects, the first monitoring interval may range from 0.1 seconds to 2 seconds.

In some aspects, at stage 408 (labeled as “Check Proximity #2”) after the consumer SDK 316 determines that the user device 310 is within the reference radius from at least one POI device, the consumer SDK 316 may check if the user device 310 is within a reference distance from any of the at least one POI device. In some aspects, the location (e.g., an absolute position) of the user device 310 for stage 408 may be obtained based on scanning and decrypting payloads carried by beacon signals, advertising signals, or positioning reference signals from one or more POI devices at the location of interest. In some aspects, a distance (e.g., a relative position) of the user device 310 with respect to the POI device 320 may be determined based on the user device 310 measuring a time of flight, time of arrival, or signal strength of the reference signals (e.g., beacon signals, advertising signals, or positioning reference signals) from the POI device 320 without determining the finer location (e.g., an absolute position) of the user device 310.

In some aspects, the beacon signals, advertising signals, or positioning reference signals may be based on BLE, UWB, WLAN, sidelink, or the like. In some aspects, the reference distance may be 1 m (which may correspond to an equivalent time of flight, time of arrival, or signal strength of the reference signals for a relative position based determination). In some aspects, at stage 408, the consumer SDK 316 may monitor the signals for positioning based on a second monitoring interval that is equal to or less than the first monitoring interval. In some aspects, the consumer SDK 316 may monitor the signals for positioning continuously without considering the second monitoring interval.

In some aspects, the reference radius at stage 406 and the reference distance at stage 408 may be configurable based on various use cases implementing the solution as described herein and the technology employed. For example, we can set a shorter reference radius when stage 406 is based on UWB than that for BLE. In some aspects, the reference radius at stage 406 and the reference distance at stage 408 may be set based on the wireless signal strength of the POI device.

In some aspects, at stage 412 after the consumer SDK 316 determines that the user device 310 is within the reference distance from a POI device (e.g., the POI device 320), the consumer SDK 316 may send a POI entry message to the application layer 314. In some aspects, the POI entry message may include information such as the POI identifier of the POI device 320, a location of the user device 310, and/or a zone in which the user device 310 is located. In some aspects, at stage 414, the application layer 314 may instruct the consumer SDK 316 to start a D2D communication with the POI device 320. In some aspects, at stage 414, the application layer 314 may provide user data (including, e.g., user identifier and/or user device identifier) to be used in a secure data transaction (e.g., a payment process) to the consumer SDK 316. In some aspects, the operations at stage 414 may be automatically triggered based on information received at stage 412. In some aspects, the operations at stage 414 may be made available (or enabled) for a user of the user device 310 based on information received at stage 412, and then may be actually triggered based on a user command or a user operation of the user device 310.

In some aspects, at stage 416, the consumer SDK 316 may establish a D2D communication with the POI SDK 370 and perform an authentication procedure (e.g., a mutual authentication procedure) based on exchange of encrypted authentication information between the user device 310 and the POI device 320 in order to ensure that the D2D communication is a D2D mutual authenticated connection. After establishing the D2D communication being a D2D mutual authenticated connection, as a non-limiting example, the consumer SDK 316 may send the user data to the POI SDK 370 via the D2D communication at stage 418. In some aspects, after establishing the D2D communication at stage 416, the POI device 320 may send information to the user device 310, as a D2D communication may support a two-way communication.

In some aspects, the operations at stages 406-416 may be based on one or more wireless technology. In one example, the operations at stages 406-416 may be all based on a same one of sidelink, BLE, UWB, or Wi-Fi. In one example, the operations at stages 406-408 may be based on UWB or Wi-Fi, and operations at stages 412-416 may be based on sidelink or BLE.

In some aspects, one or more other user devices may perform operations associated with stages 402-418 to provide respective one or more sets of user data. In some aspects, at stage 422, the POI SDK 370 may collect the one or more sets of user data from one or more corresponding user devices. In some aspects, the POI device 320 may receive multiple sets of user data from multiple user device based on queue handling, as a number of the communication channels supported by the POI device 320 may be limited (e.g., up to four channels in some examples).

In some aspects, one user device 310 may perform operations associated with stages 402-418 to provide user data to multiple POI devices 320. The first POI device to respond with a connection may be chosen by consumer SDK 316 to provide user data for stage 422 and secure transaction.

In some aspects, at stage 422, the POI SDK 370 may post all the collected user data from all connected user devices to the POI application 322. In some aspects, at stage 424 (labeled as “pick a user”), the POI application 322 may pick a user device (e.g., the user device 310) for further transaction processing. In some aspects, at stage 426, the POI application 322 may indicate a connection identifier (also referred to as “Connection ID”) associated with a selected user device to the POI SDK 370. In some aspects, the POI SDK 370 may send a transaction acknowledgement indication (labeled “Transaction Ack”) to the consumer SDK 316 of the user device 310 based on the connection identifier from stage 428; and the consumer SDK 316 may forward the transaction acknowledgement indication (labeled “Transaction Ack”) to the application layer 314 at stage 429.

In some aspects, at stage 432, the application layer 314 may instruct the consumer SDK 316 to resume the D2D communication with the POI device 320. In some aspects, at stage 432, the application layer 314 may provide transaction data to be used in the secure data transaction (e.g., for a payment process) to the consumer SDK 316. In some aspects, the consumer SDK 316 may encrypt the transaction data and send the encrypted transaction data to the POI SDK 370 via the D2D communication at stage 434. In some aspects, at stage 436, the POI SDK 370 may forward the encrypted transaction data to the POI application 322 together with an attestation report for verifying authenticity of the POI device 320 and the encrypted transaction data. In some aspects, at stage 438, the POI application 322 may forward the encrypted transaction data together with the attestation report to the POI application host device 350.

In some aspects, at stage 442, the POI application host device 350 may send the encrypted transaction data together with the attestation report to the transaction microservice 334 of the server device 330. In some aspects, at stage 444, the transaction microservice 334 may verify the authenticity of the POI device 320 and the authenticity of the encrypted transaction data based on the attestation report in association with the POI device 320. In some aspects, after the authenticity of the POI device 320 and the authenticity of the encrypted transaction data can be verified at stage 444, the transaction microservice 334 may decrypt the encrypted transaction data at stage 446 and send the decrypted transaction data to the POI application host device 350 at stage 448.

In some aspects, at stage 452, the POI application host device 350 may process the decrypted transaction data and record the transaction. In some aspects, at stage 454, the POI application host device 350 may send receipt data to the POI application 322, where the receipt data may correspond to the result of processing the decrypted transaction data. In some aspects, at stage 456, the POI application 322 may forward the receipt data to the POI SDK 370 together with the connection identifier associated with the user device 310. In some aspects, at stage 458, the POI SDK 370 may send the receipt data to the consumer SDK 316 of the user device 310 based on the connection identifier from stage 456; and the consumer SDK 316 may forward the receipt data to the application layer 314 at stage 459.

In some aspects, at stage 462, the application layer 314 may instruct the consumer SDK 316 to close the D2D communication with the POI device 320. In some aspects, at stage 464, the consumer SDK 316 may terminate the D2D communication with the POI SDK 370 (labeled as “D2D Disconnection”). In some aspects, the D2D communication may remain connected even after the receipt data is received, and stages 462 and 464 may be omitted.

In some aspects, to provide an additional layer of security, the user device 310 may send the finer location of the user device 310 determined at stage 408, which may be in the form of coordinates with respect to the location of interests (e.g., X/Y coordinates inside the store) or a greater area (e.g., latitude/longitude), to the POI device and/or the server device 330. In some aspects, the finer location of the user device 310 may be included in the user data at stage 414, the transaction data at stage 432, and/or the information for the authentication procedure at stage 416.

In some aspects, the user device 310 in this disclosure may correspond to a processing device that is a mobile device or a UE. In some aspects, the user device 310 in this disclosure may correspond to a processing device onboard a vehicle, and the POI device 320 may correspond to a stationary terminal (e.g., as an infrastructure at a parking lot, parking café, charging station, or the like), another vehicle, or another user device carried by a user (e.g., a pedestrian or a bicyclist). In such scenario, the D2D connection may correspond to a car-to-everything (C2X) communication, such as a vehicle-to-vehicle (V2V) communication, a vehicle-to-infrastructure (V2I) communication, a vehicle-to-pedestrian (V2P) communication, a vehicle-to-device (V2D) communication, or a vehicle-to-everything (V2X) communication. In such scenario, stage 422 may correspond to post all the collected user data from all connected user devices (including vehicles/processing devices onboard vehicles). In such scenario, stage 424 may correspond to picking a user device from the connected user devices (including vehicles/processing devices onboard vehicles).

In some aspects, the process flow 400A shows an example for data transmission of data with encryption. In some aspects, the process flow 400A may be slightly modified for data transmission of data without encryption, and the operations regarding encrypting and/or decrypting data may be skipped.

FIGS. 4C and 4D show a diagram illustrating a second example process flow 400B for a secure data transaction, according to aspects of the disclosure. In some aspects, the process flow 400B may correspond to operations performed by the application layer 314, the consumer SDK 316, the POI SDK 370, the transaction microservice 334, and the user application host device 340, as shown in FIG. 3B.

In some aspects, the entities for performing various operations are depicted in FIGS. 4C and 4D as a non-limiting example. In some aspects, the operations illustrated as performed by the application layer 314 and the consumer SDK 316 in FIGS. 4C and 4D may be performed by various components of the user device 310; the operations illustrated as performed by the POI SDK 370 in FIGS. 4C and 4D may be performed by various components of the POI device 320; and the operations illustrated as performed by the transaction microservice 334 in FIGS. 4C and 4D may be performed by various components of the server device 330.

As shown in FIG. 4C, the process flow 400B may include stages 401, 402, 404, 406, 408, 412 that may be similar to stages 401, 402, 404, 406, 408, and 412 of the process flow 400A in FIG. 4A, and description thereof may be simplified or omitted.

In some aspects, after receiving the POI entry message from stage 412, the application layer 314 may instruct the consumer SDK 316 to start a D2D communication with the POI device 320 at stage 415. In some aspects, at stage 415, the application layer 314 may provide user data and transaction data to be used in a secure data transaction (e.g., a payment process) to the consumer SDK 316.

In some aspects, at stage 416, the consumer SDK 316 may establish a D2D communication with the POI SDK 370 and perform a authentication procedure (e.g., a mutual authentication procedure) based on exchange of encrypted authentication information between the user device 310 and the POI device 320 in order to ensure that the D2D communication is a D2D mutual authenticated connection. After establishing the D2D communication being a D2D mutual authenticated connection, the consumer SDK 316 may send the user data to the POI SDK 370 via the D2D communication at stage 419. In some aspects, the consumer SDK 316 may encrypt the transaction data and send the encrypted transaction data to the POI SDK 370 via the D2D communication at stage 419.

As shown in FIG. 4D, after stage 419, the process flow 400B may proceed to stage 443. In some aspects, at stage 443, the POI SDK 370 may forward the encrypted transaction data to the transaction microservice 334 together with an attestation report for verifying authenticity of the POI device 320 and authenticity of the encrypted transaction data. In some aspects, at stage 444, the transaction microservice 334 may verify the authenticity of the POI device 320 and the authenticity of the encrypted transaction data based on the attestation report in association with the POI device 320. In some aspects, after the validity of the POI device 320 and the validity of the encrypted transaction data can be verified at stage 444, the transaction microservice 334 may decrypt the encrypted transaction data, process the decrypted transaction data, and record the transaction at stage 445.

In some aspects, at stage 472, the transaction microservice 334 may send a new transaction message to the user application host device 340 using message webhooks. In some aspects, at stage 474, the user application host device 340 may, based on the new transaction message, fetch the processed transaction data from the transaction microservice 334. In some aspects, at stage 476, the user application host device 340 may send receipt data to the transaction microservice 334, where the receipt data may correspond to the result of processing the decrypted transaction data.

In some aspects, at stage 478, the transaction microservice 334 may forward the receipt data to the POI SDK 370 together with the connection identifier associated with the user device 310. In some aspects, at stage 458, the POI SDK 370 may send the receipt data to the consumer SDK 316 of the user device 310 based on the connection identifier from stage 478; and the consumer SDK 316 may forward the receipt data to the application layer 314 at stage 459.

In some aspects, at stage 462, the application layer 314 may instruct the consumer SDK 316 to close the D2D communication with the POI device 320. In some aspects, at stage 464, the consumer SDK 316 may terminate the D2D communication with the POI SDK 370 (labeled as “D2D Disconnection”). In some aspects, the D2D communication may remain connected even after the receipt data is received, and stages 462 and 464 may be omitted.

In some aspects, to provide an additional layer of security, the user device 310 may send the finer location of the user device 310 determined at stage 408, which may be in the form of coordinates with respect to the location of interests (e.g., X/Y coordinates inside the store) or a greater area (e.g., latitude/longitude), to the POI device and/or the server device 330. In some aspects, the finer location of the user device 310 may be included in the user data at stage 415, the transaction data at stage 415, and/or the information for the authentication procedure at stage 416.

In some aspects, the process flow 400B shows an example for data transmission of data with encryption. In some aspects, the process flow 400B may be slightly modified for data transmission of data without encryption, and the operations regarding encrypting and/or decrypting data may be skipped.

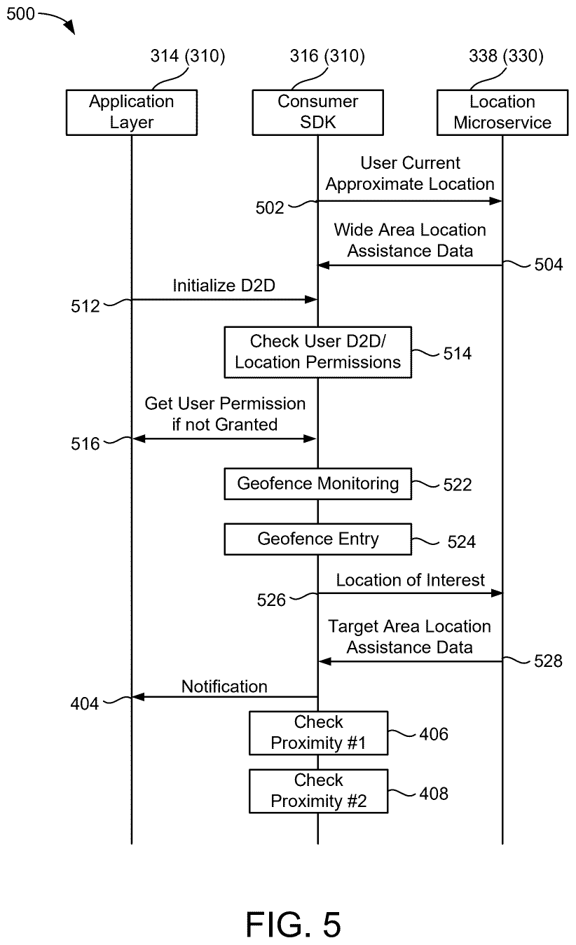

FIG. 5 shows a diagram illustrating an example process flow 500 for determining a location of a user device, according to aspects of the disclosure. In some aspects, the process flow 500 may correspond to operations performed by the application layer 314, the consumer SDK 316, and the location microservice 338 as shown in FIGS. 3A and 3B. In some aspects, the process flow 500 may correspond to operations performed before and up to stage 408 in FIGS. 4A and 4C.

In some aspects, at stage 502, the consumer SDK 316 may inform the location microservice 338 about a user current approximate location of the user device 310. In some aspects, at stage 504, based on the user current approximate location, the location microservice 338 may provide location assistance data regarding an area that may encompass one or more locations of interests (labeled “Wide Area Location Assistance Data”). In some aspects, as the locations of interests may correspond to various stores, the location assistance data from stage 504 may also referred to as outdoor location assistance data.

In some aspects, at stage 512, the application layer 314 may instruct the consumer SDK 316 to initiate D2D service (e.g., the D2D service 369). In some aspects, at stage 514, the consumer SDK 316 may check if the user of the user device has provided permissions to perform D2D services and/or location services. In some aspects, at stage 516, if the user has not granted the permissions, the consumer SDK 316 may work with the application layer 314 to obtain the user permissions. In some aspects, stages 512, 514, and 516 may be performed before, concurrently, or after stages 502 and 504.

In some aspects, at stage 522, the consumer SDK 316 may monitor if the user device 310 enters one or more geofences associated with one or more locations of interests based on the location assistance data from stage 504. In some aspects, at stage 524, the consumer SDK 316 may determine that the user device 310 may enter at least one geofence. In some aspects, stages 522 and 524 may correspond to stage 402 in FIGS. 4A and 4C. As illustrated with reference to FIG. 4A, the location of the user device 310 for geofence monitoring at stages 522 and 524 may be obtained based on GNSS, LTE positioning, 5G positioning, or the like.

In some aspects, after the consumer SDK 316 determines that the user device 310 has entered the geofence (e.g., of the store), the consumer SDK 316 may indicate the location of interests associated with the geofence entered by the user device 310 at stage 526. In some aspects, at stage 528, based on the location of interests from stage 526, the location microservice 338 may provide location assistance data regarding the location of interests (labeled “Target Area Location Assistance Data”). In some aspects, as the locations of interests may correspond to stores, the location assistance data from stage 528 may also referred to as indoor location assistance data for the store.

In some aspects, after the consumer SDK 316 determines that the user device 310 has entered the geofence (e.g., of the store, or a truck entering a warehouse parking lot), the consumer SDK 316 may send a notification to the application layer 314 at stage 404. In some aspects, the consumer SDK 316 may determine if the user device 310 is in close proximity to a POI device at stages 406 and 408 as shown in FIGS. 4A and 4C. In some aspects, stages 526 and 528 may be performed before stages 402 and 406, and may be performed before, concurrently, or after stage 404.

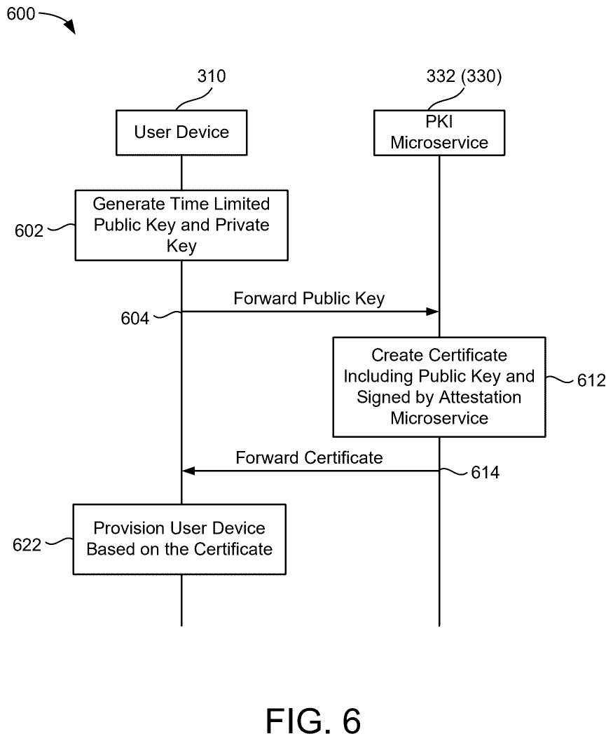

FIG. 6 shows a diagram illustrating an example process flow 600 for provisioning a user device (e.g., the user device 310), according to aspects of the disclosure. In some aspects, the process flow 600 may correspond to operations performed by the user device 310 and the PKI microservice 332 as shown in FIGS. 3A and 3B. In some aspects, the process flow 600 may correspond to operations performed before stage 402 in FIGS. 4A and 4C.

In some aspects, at stage 602, the user device 310 may generate a time-limited public key and a time-limited private key of the user device. In some aspects, at stage 604, the user device 310 may forward the public key of the user device to the PKI microservice 332. In some aspects, at stage 612, the PKI microservice 332 may create a user device certificate that may include the public key of the user device and may be signed by the attestation microservice 336. In some aspects, at stage 614, the PKI microservice 332 may forward the user device certificate to the user device 310.

In some aspects, at stage 622, the user device may be provisioned based on the received user device certificate. In some aspects, the user device certificate may include the public key of the user device and may be signed by the attestation microservice 336.

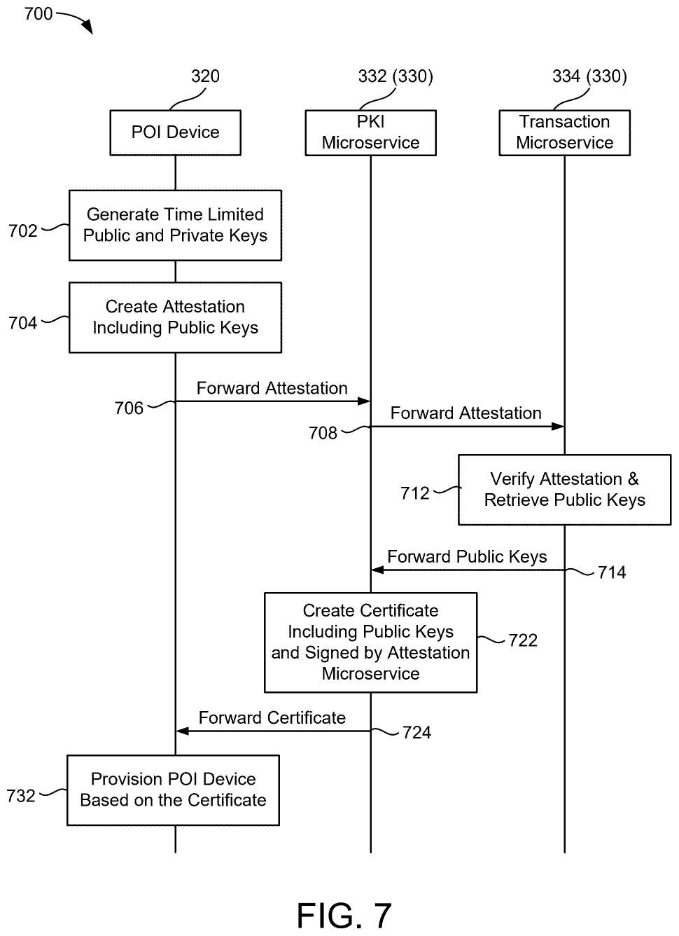

FIG. 7 shows a diagram illustrating an example process flow for provisioning a POI device (e.g., the POI device 320), according to aspects of the disclosure. In some aspects, the process flow 600 may correspond to operations performed by the POI device 320, the PKI microservice 332, and the transaction microservice 334 as shown in FIGS. 3A and 3B. In some aspects, the process flow 700 may correspond to operations performed before stage 402 in FIGS. 4A and 4C.

In some aspects, at stage 702, the POI device 310 may generate a time-limited public key and a time-limited private key of the POI device. In some aspects, at stage 704, the POI device 310 may create attestation information for verifying the authenticity of the POI device 320. In some aspects, the attestation information may include the public key of the POI device. In some aspects, the POI device 320 may forward the attestation information to the PKI microservice 332 at stage 706; and the PKI microservice 332 may forward the attestation information to the transaction microservice 334 at stage 708.

In some aspect, at stage 712, the transaction microservice 334 may verify the attestation information and may retrieve the public key of the POI device from the attestation information. In some aspects, at stage 714, the transaction microservice 334 may forward the public key of the POI device to the PKI microservice 332. In some aspects, at stage 722, the PKI microservice 332 may create a POI device certificate that may include the public key of the POI device and may be signed by the attestation microservice 336. In some aspects, at stage 724, the PKI microservice 332 may forward the POI device certificate to the POI device 320.

In some aspects, at stage 732, the POI device may be provisioned based on the received POI device certificate. In some aspects, the POI device certificate may include the public key of the POI Device and may be signed by the attestation microservice 336.

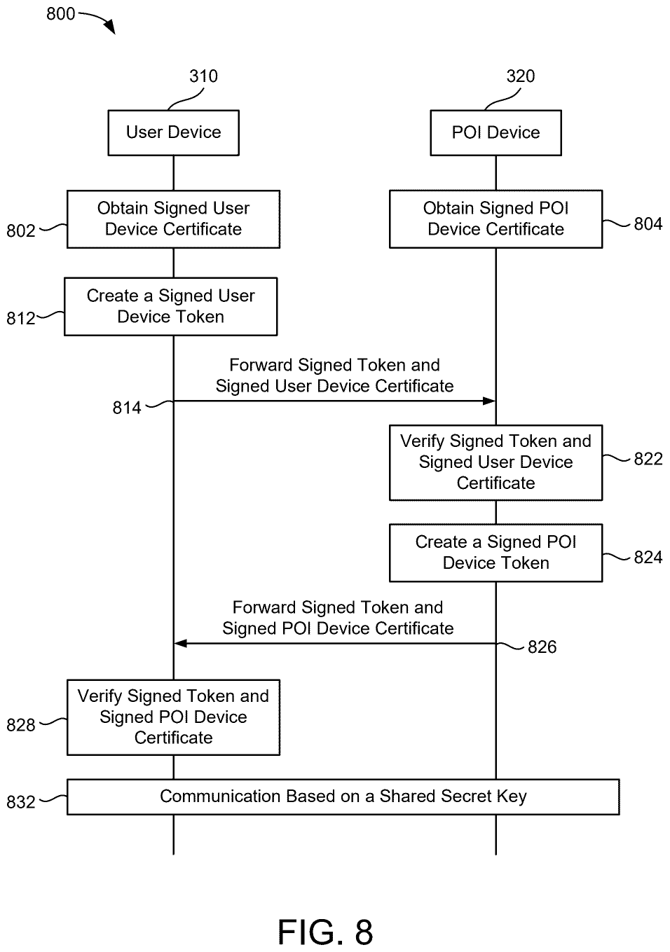

FIG. 8 shows a diagram illustrating an example process flow 800 for a mutual authentication procedure, according to aspects of the disclosure. In some aspects, the process flow 800 may correspond to operations performed by the user device 310 and the POI device 320 as shown in FIGS. 3A and 3B. In some aspects, a portion of the process flow 800 may correspond to operations performed before stage 402 in FIGS. 4A and 4C; and a portion of the process flow 800 may correspond to operations performed during stage 416 in FIGS. 4A and 4C.

In some aspects, at stage 802, the user device 310 may obtain a signed user device certificate as illustrated in FIG. 6. In some aspects, at stage 804, the user device 310 may obtain a signed POI device certificate as illustrated in FIG. 7. In some aspects, stages 802 and 804 may correspond to operations performed before stage 402 in FIGS. 4A and 4C. In some aspects, the signed user device certificate includes a public key of the user device; and the signed POI device certificate includes a public key of the POI device.

In some aspects, at stage 812, the user device 310 may create a signed user device token. In some aspects, at stage 814, the user device 310 may forward the signed user device token and the signed user device certificate to the POI device 320. In some aspects, user device may create ephemeral key-pair (including an ephemeral public key and an ephemeral private key) of the user device based on Elliptic-curve Diffie-Hellman (ECDH) protocol. In some aspects, the user device 310 may compute a hash value of a shared secret key based on a secure hash algorithm 256 (SHA-256) algorithm; create a JSON Web Token (JWT); and sign the token using elliptic curve digital signature algorithm (ECDSA) with the ephemeral private key of the user device and the hash value to obtain the signed user device token.

In some aspects, at stage 822, the POI device 320 may verify the signed user device certificate and may extract the public key of the user device (time limited public key from FIG. 6) from the signed user device certificate. In some aspects, at stage 822, the POI device 320 may verify the signed user device token using ECDSA with the public key of the user device and the hash value, and extract the ephemeral public key of the user device from the signed user device token.

In some aspects, at stage 824, the POI device 320 may create a signed POI device token. In some aspects, at stage 826, the POI device 320 may forward the signed POI device token and the signed POI device certificate to the user device 310. In some aspects, POI device may create ephemeral key-pair (including an ephemeral public key and an ephemeral private key) of the POI device based on ECDH protocol. In some aspects, the POI device 320 may compute a hash value of the shared secret key based on SHA-256 algorithm; create a JSON Web Token (JWT); and sign the token using ECDSA with the ephemeral private key of the POI device and the hash value to obtain the signed POI device token.

In some aspects, at stage 828, the user device 310 may verify the signed POI device certificate and may extract the public key of the POI device (time limited public key from FIG. 7) from the signed POI device certificate. In some aspects, at stage 828, the user device 310 may verify the signed POI device token using ECDSA with the public key of the POI device and the hash value, and extract the ephemeral public key of the POI device from the signed user device token.

In some aspects, at stage 832, after the user device 310 and the POI device 320 are mutually authenticated based on the signed tokens and signed certificates, the user device 310 and the POI device 320 may communicate with each other based on the shared secret key. In some aspects, stages 812, 814, 822, 824, 826, 828, and 832 may correspond to operations performed during stage 416 in FIGS. 4A and 4C.

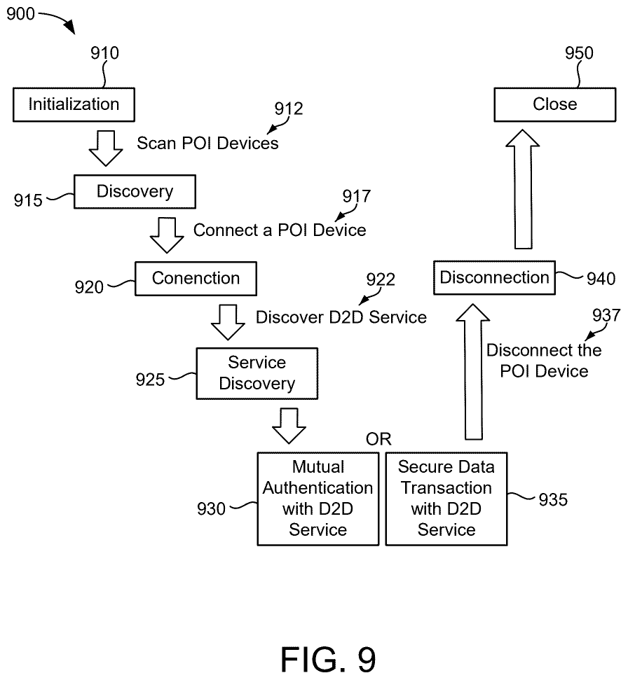

FIG. 9 shows a diagram illustrating an example processing sequence 900 of a device-to-device (D2D) service of a consumer SDK (e.g., the consumer SDK 316 in FIGS. 3A and 3B), according to aspects of the disclosure.

As shown in FIG. 9, the processing sequence 900 may start at an initialization component 910 for initializing the consumer SDK. In some aspects, for scanning POI devices (action 912), the processing sequence 900 may proceed from the initialization component 910 to a discovery component 915. In some aspects, for connecting a POI device (action 917), the processing sequence 900 may proceed from the discovery component 915 to a connection component 920. In some aspects, for discovering a D2D service (action 922), the processing sequence 900 may proceed from the connection component 920 to a service discovery component 925.

In some aspects, after the service discovery component 925, the processing sequence 900 may proceed to a mutual authentication with D2D service component 930 and/or a secure data transaction with D2D service component 935. In some aspects, after the operations of the mutual authentication with D2D service component 930 and/or the secure data transaction with D2D service component 935, for disconnecting the POI service (action 937), the processing sequence 900 may proceed to a disconnection component 940. In some aspects, after disconnecting the POI service by the disconnection component 940, the processing sequence 900 may proceed to a close component 950 and terminates.

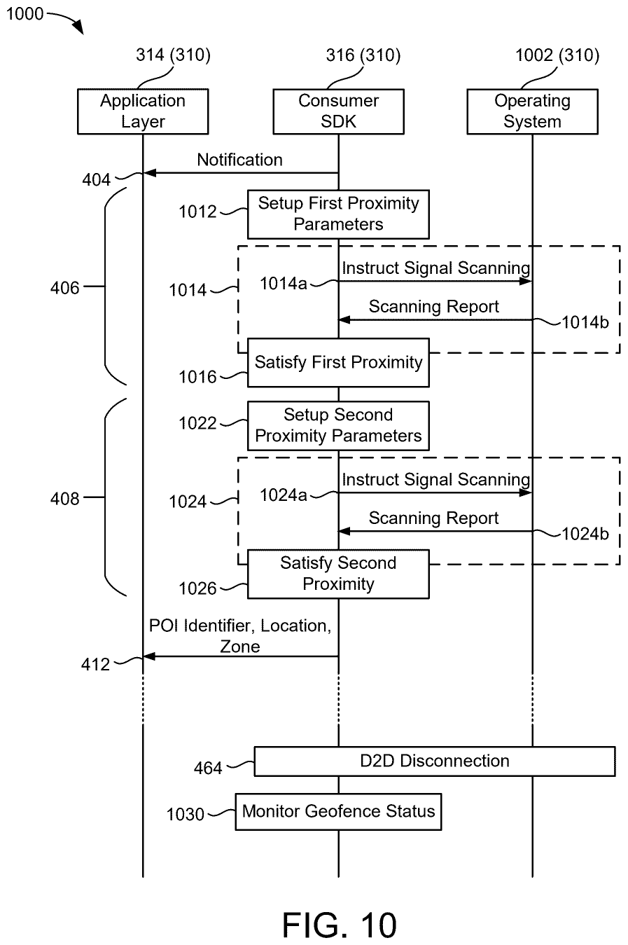

FIG. 10 shows a diagram illustrating an example process flow 1000 for proximity operation sequences by a user device (e.g., the user device 310), according to aspects of the disclosure. In some aspects, the process flow 1000 may correspond to operations performed by the application layer 314 and the consumer SDK 316 of the user device 310 as shown in FIGS. 3A and 3B, together with an operating system 1002 of the user device 310. In some aspects, the process flow 100 may correspond to operations performed at stages 404-412 in FIGS. 4A and 4C and after stage 464 in FIGS. 4B and 4D.

In some aspects, after the consumer SDK 316 determines that the user device 310 has entered the geofence (e.g., of a store), the consumer SDK 316 may send a notification to the application layer 314 at stage 404. As shown in FIG. 10, after stage 404, stage 406 may include stages 1012-1016; and stage 408 may include stages 1022-1026.

In some aspects, at stage 1012, the consumer SDK 316 may setup a first set of parameters for determining if the user device 310 is within a the proximity area of at least one POI devices in the location of interests associated with the geofence (e.g., the store). In some aspects, the first set of parameters may include a reference radius for defining the proximity area of the POI device. In some aspects, the first set of parameters may include a first monitoring interval for monitoring signals from various POI devices. In some aspects, the reference radius may range from 3 m to 6 m. In. some aspects, the reference radius may be 5 m. In some aspects, the first monitoring interval may range from 0.1 seconds to 2 seconds.

In some aspects, at stage 1014, the consumer SDK 316 may work with the operating system 1002 to monitor signals from various POI devices. In some aspects, at stage 1014a, the consumer SDK 316 may instruct the operating system 1002 to scan signals from POI devices. In some aspects, at stage 1014b, the operating system 1002 may send a scanning report to the consumer SDK 316. During stage 1014, the consumer SDK 316 may determine if the user device 310 is within the first reference distance from at least one POI device based on the scanning report. In some aspects, stage 1014a and stage 1014b and the corresponding determination may be performed periodically based on the first monitoring interval.

In some aspects, at stage 1016, the consumer SDK 316 may determine that the user device 310 is within the reference radius from at least one POI device (i.e., satisfying the first proximity condition), the process flow 1000 may leave stage 1014 and proceed to stage 1022.

In some aspects, at stage 1022, the consumer SDK 316 may setup a second set of parameters for determining if the user device 310 is within a reference distance from a POI device in the location of interests associated with the geofence (e.g., the store). In some aspects, the second set of parameters may include the reference distance. In some aspects, the second set of parameters may include a second monitoring interval for monitoring signals from various POI devices. In some aspects, the reference distance may range from 0.5 m to 1.5 m. In. some aspects, the reference distance may be 1 m. In some aspects, the second monitoring interval may be equal to or less than the first monitoring interval. In some aspects, the second monitoring interval may be omitted.

In some aspects, at stage 1024, the consumer SDK 316 may work with the operating system 1002 to monitor signals from various POI devices. In some aspects, at stage 1024a, the consumer SDK 316 may instruct the operating system 1002 to scan signals from POI devices. In some aspects, at stage 1024b, the operating system 1002 may send a scanning report to the consumer SDK 316. During stage 1024, the consumer SDK 316 may determine if the user device 310 is within the second reference distance from at least one POI device based on the scanning report. In some aspects, stage 1024a and stage 1024b and the corresponding determination may be performed periodically based on the second monitoring interval. In some aspects, stage 1024a and stage 1024b and the corresponding determination may repeat continuously without considering the second monitoring interval.

In some aspects, at stage 1026, the consumer SDK 316 may determine that the user device 310 is within the reference distance from a POI device (i.e., satisfying the second proximity condition), the process flow 1000 may leave stage 1014 and proceed to stage 412.

As shown in FIG. 10 in view of FIGS. 4B and 4D, after stage 464, the consumer SDK may keep monitoring the geofence status at stage 1030. In some aspects, in a case that the user device remains in the geofence (i.e., stay in the store), the process flow 1000 (or the process flow 400A or the process flow 400B) may resume at stage 406. In some aspects, in a case that the user device moves outside of the geofence (i.e., leave the store), the process flow 1000 (or the process flow 400A or the process flow 400B) may terminate, and the consumer SDK 316 may operate based on the process flow 500 in FIG. 5 (e.g., starting at stage 502 or stage 522).

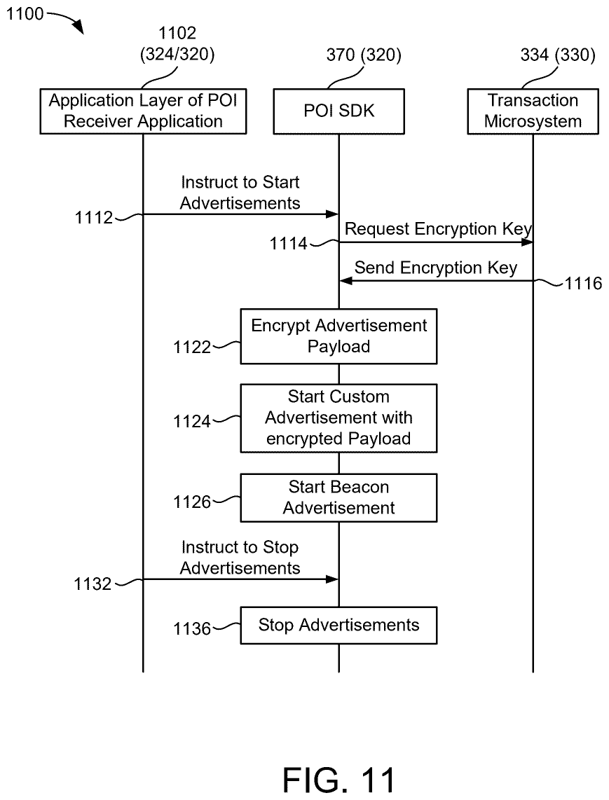

FIG. 11 shows a diagram illustrating an example process flow 1100 for advertisement sequences by a POI device (e.g., the POI device 320), according to aspects of the disclosure. In some aspects, the process flow 1100 may correspond to operations performed by an application layer 1102 of the POI receiver application 324, the POI SDK 370, and the transaction microservice 334 as shown in FIGS. 3A and 3B.

In some aspects, at stage 1112, the application layer 1102 of the POI receiver application 324 may instruct the POI SDK 370 to start sending advertisements. In some aspects, at stage 1114, the POI SDK 370 may send a request to the transaction microservice 334 asking for an encryption key associated with one or more user devices. In some aspects, at stage 1116, the transaction microservice 334 may send the an encryption key associated with one or more user devices to the POI SDK 370.

In some aspects, at stage 1122, the POI SDK 370 may encrypt advertisement payload based on the encryption key. In some aspects, the advertisement payload may include a retailer identifier, a store identifier, a POI device identifier, a zone associated with the retailer/store, a floor associated with the retailer/store, or any combination thereof. In some aspects, at stage 1124, the POI SDK 370 may start a custom advertisement with the encrypted advertisement payload. In some aspects, at stage 1126, the POI SDK 370 may start a beacon advertisement that is not based on the encrypted advertisement payload.

In some aspects, at stage 1132, the application layer 1102 of the POI receiver application 324 may instruct the POI SDK 370 to stop sending advertisements. In some aspects, at stage 1136, the POI SDK 370 may stop sending advertisements.

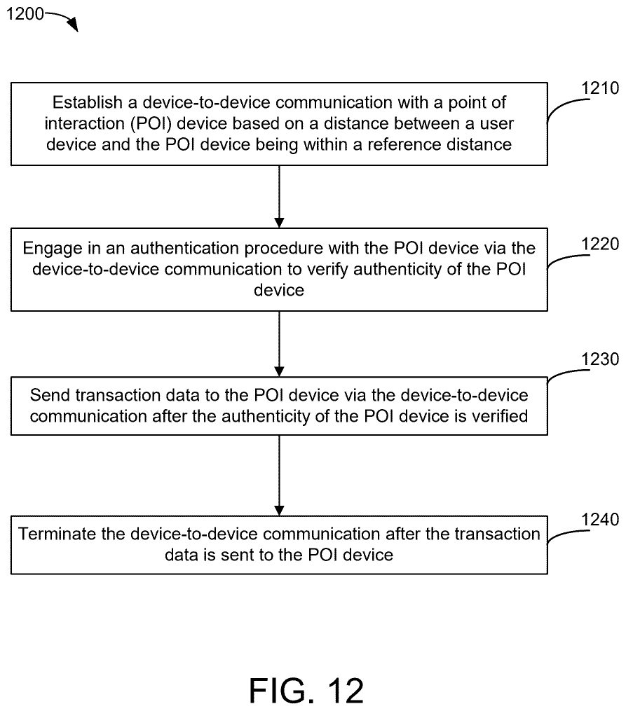

FIG. 12 illustrates a method 1200 of wireless communication performed by a user device (e.g., the user device 310 described herein), according to aspects of the disclosure. In some aspects, the user device may correspond to the processing device 200 described in FIG. 2; and the method 1200 may be performed by the one or more WWAN transceivers 210, the one or more short-range wireless transceivers 220, the one or more network transceivers 244, the one or more processors 242, the memory 240, and/or the secure transaction component 248, any or all of which may be considered means for performing one or more of the following operations of method 1200.

At operation 1210, the user device (e.g., the user device 310) may establish a D2D communication with a POI device (e.g., the POI device 320) based on a distance between the user device and the POI device being within a reference distance. In some aspects, operation 1210 may correspond to stages 402-416 in FIGS. 4A and 4C. In some aspects, operation 1210 may be performed by the one or more WWAN transceivers 210, the one or more short-range wireless transceivers 220, the one or more network transceivers 244, the one or more processors 242, the memory 240, and/or the secure transaction component 248, any or all of which may be considered means for performing operation 1210.

In some aspects, the POI may be a stationary device, a portable device, or another user device (e.g., held by a user or disposed on a vehicle). In some aspects, the D2D communication may be based on BLE technology, UWB technology, WLAN technology, or sidelink communication technology (e.g., LTE, 5G, or the like).

In some aspects, the method 1200 may include detecting, based on a first monitoring interval, whether the user device enters a proximity area defined based on a location of the POI device. In some aspects, the method 1200 may include detecting, after detection of the user device entering the proximity area and based on a second monitoring interval, whether the distance between the user device and the POI device is within the reference distance. In some aspects, the second monitoring interval may be equal to or less than the first monitoring interval. In some aspects, the method 1200 may include continuously detecting, after detection of the user device entering the proximity area, whether the distance between the user device and the POI device is within the reference distance. In some aspects, the method 1200 may include obtaining a location of the user device (e.g., the store the user device entered), and configure the proximity area based on an identifier of the POI device in association with the location of the user device. In some aspects, the proximity area may correspond to within a five-meter radius from the POI device. In some aspects, the reference distance may correspond to one meter.

At operation 1220, the user device may engage in an authentication procedure with the POI device via the device-to-device communication to verify authenticity of the POI device. In some aspects, operation 1220 may correspond to a portion of stage 416 in FIGS. 4A and 4C. In some aspects, operation 1220 may be performed by the one or more WWAN transceivers 210, the one or more short-range wireless transceivers 220, the one or more network transceivers 244, the one or more processors 242, the memory 240, and/or the secure transaction component 248, any or all of which may be considered means for performing operation 1220.

In some aspects, the authentication procedure may be a mutual authentication procedure based on exchange of encrypted authentication information. In some aspects, the authentication procedure may be based on the process flow 700 illustrated in FIG. 7.

At operation 1230, the user device may send transaction data to the POI device via the D2D communication after the authenticity of the POI device is verified. In some aspects, operation 1230 may correspond to stage 432 in FIG. 4B or stage 415 in FIG. 4C. In some aspects, operation 1230 may be performed by the one or more WWAN transceivers 210, the one or more short-range wireless transceivers 220, the one or more network transceivers 244, the one or more processors 242, the memory 240, and/or the secure transaction component 248, any or all of which may be considered means for performing operation 1230.

In some aspects, based on the example shown in FIG. 4A, the method 1200 may include sending user data to the POI device via the D2D communication after the authenticity of the POI device is verified; and receiving a transaction acknowledgement indication from the POI device via the D2D communication. In some aspects, the transaction data may be sent to the POI device after the transaction acknowledgement indication is received. In some aspects, the transaction acknowledgement indication may be based on the user data.

In some aspects, based on the example shown in FIG. 4C, the method 1200 may include sending user data to the POI device via the D2D communication after the authenticity of the POI device is verified; without waiting for the transaction acknowledgement indication.

In some aspects, the user device may send a location of the user device (e.g., the finer location of the user device used for the proximity determination) to the POI device and/or the server device. In some aspects, as illustrated in FIGS. 4A-4C, the finer location of the user device may be included in the user data at stage 414, the transaction data at stage 432, and/or the information for the authentication procedure at stage 416.

At operation 1240, the user device may terminate the device-to-device communication after the transaction data is sent to the POI device. In some aspects, operation 1240 may correspond to stages 462 and 464 in FIGS. 4A and 4C. In some aspects, operation 1240 may be performed by the one or more WWAN transceivers 210, the one or more short-range wireless transceivers 220, the one or more network transceivers 244, the one or more processors 242, the memory 240, and/or the secure transaction component 248, any or all of which may be considered means for performing operation 1240.

In some aspects, the method 1200 may include receiving receipt data corresponding to processing of the transaction data from the POI device via the device-to-device communication. In some aspects, the D2D communication may be terminated after the receipt data is received. In some aspects, the D2D communication may remain connected even after the receipt data is received.

As will be appreciated, a technical advantage of the method 1200 is triggering a secure data transaction using a D2D communication between a user device and a POI device based on determining that the user device is in close proximity to the POI device. In some examples, the proximity location based triggering as illustrated may provide an additional layer of security (based on the proximity and authentication between the devices) for the secure data transaction, while the D2D communication may still allow a secure short-range or mid-range communication. Accordingly, a secure data transaction between the user device and the POI device (e.g., for a payment process) may be performed with improved security and convenience of the users.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

### Implementation Examples are Described in the Following Numbered Clauses:

Clause 1. A method of wireless communication performed by a user device, the method comprising: establishing a device-to-device communication with a point of interaction (POI) device based on a distance between the user device and the POI device being within a reference distance; engaging in an authentication procedure with the POI device via the device-to-device communication to verify authenticity of the POI device; sending transaction data to the POI device via the device-to-device communication after the authenticity of the POI device is verified; and terminating the device-to-device communication after the transaction data is sent to the POI device.

Clause 2. The method of clause 1, further comprising: sending a location of the user device to the POI device via the device-to-device communication.

Clause 3. The method of any of clauses 1 to 2, further comprising: receiving receipt data corresponding to processing of the transaction data from the POI device via the device-to-device communication.

Clause 4. The method of any of clauses 1 to 3, further comprising: detecting, based on a first monitoring interval, whether the user device enters a proximity area defined based on a location of the POI device; and detecting, after detection of the user device entering the proximity area and based on a second monitoring interval, whether the distance between the user device and the POI device is within the reference distance, wherein the second monitoring interval is equal to or less than the first monitoring interval.

Clause 5. The method of clause 4, further comprising: obtaining a location of the user device; and configuring the proximity area based on an identifier of the POI device in association with the location of the user device.

Clause 6. The method of any of clauses 4 to 5, wherein: the proximity area corresponds to within a five-meter radius from the POI device, and the reference distance corresponds to one meter.

Clause 7. The method of any of clauses 1 to 6, further comprising: receiving a transaction acknowledgement indication from the POI device via the device-to-device communication, wherein the sending the transaction data to the POI device is performed after the transaction acknowledgement indication is received.

Clause 8. The method of clause 7, further comprising: sending user data to the POI device via the device-to-device communication after the authenticity of the POI device is verified, wherein the transaction acknowledgement indication is based on the user data.

Clause 9. The method of any of clauses 1 to 6, further comprising: sending user data to the POI device via the device-to-device communication after the authenticity of the POI device is verified.

Clause 10. The method of any of clauses 1 to 9, wherein the authentication procedure is a mutual authentication procedure based on exchange of encrypted authentication information.

Clause 11. The method of any of clauses 1 to 10, wherein the device-to-device communication is based on: BLUETOOTH® low energy (BLE) technology, ultra-wideband (UWB) technology, wireless local area network (WLAN) technology, or sidelink communication technology.

Clause 12. A user device, comprising: one or more memories; one or more transceivers; and one or more processors communicatively coupled to the one or more memories and the one or more transceivers, the one or more processors, either alone or in combination, configured to: establish a device-to-device communication with a point of interaction (POI) device based on a distance between the user device and the POI device being within a reference distance; engage in an authentication procedure with the POI device via the device-to-device communication to verify authenticity of the POI device; send, via the one or more transceivers, transaction data to the POI device via the device-to-device communication after the authenticity of the POI device is verified; and terminate the device-to-device communication after the transaction data is sent to the POI device.

Clause 13. The method of clause 12, wherein the one or more processors, either alone or in combination, are further configured to: send a location of the user device to the POI device via the device-to-device communication.

Clause 14. The user device of any of clauses 12 to 13, wherein the one or more processors, either alone or in combination, are further configured to: receive, via the one or more transceivers, receipt data corresponding to processing of the transaction data from the POI device via the device-to-device communication.

Clause 15. The user device of any of clauses 12 to 14, wherein the one or more processors, either alone or in combination, are further configured to: detect, based on a first monitoring interval, whether the user device enters a proximity area defined based on a location of the POI device; and detect, after detection of the user device entering the proximity area and based on a second monitoring interval, whether the distance between the user device and the POI device is within the reference distance, wherein the second monitoring interval is equal to or less than the first monitoring interval.

Clause 16. The user device of clause 15, wherein the one or more processors, either alone or in combination, are further configured to: obtain a location of the user device; and configure the proximity area based on an identifier of the POI device in association with the location of the user device.

Clause 17. The user device of any of clauses 15 to 16, wherein: the proximity area corresponds to within a five-meter radius from the POI device, and the reference distance corresponds to one meter.

Clause 18. The user device of any of clauses 12 to 17, wherein the one or more processors, either alone or in combination, are further configured to: receive, via the one or more transceivers, a transaction acknowledgement indication from the POI device via the device-to-device communication, wherein the transaction data to the POI device is sent after the transaction acknowledgement indication is received.

Clause 19. The user device of clause 18, wherein the one or more processors, either alone or in combination, are further configured to: send, via the one or more transceivers, user data to the POI device via the device-to-device communication after the authenticity of the POI device is verified, wherein the transaction acknowledgement indication is based on the user data.

Clause 20. The user device of any of clauses 12 to 17, wherein the one or more processors, either alone or in combination, are further configured to: send, via the one or more transceivers, user data to the POI device via the device-to-device communication after the authenticity of the POI device is verified.

Clause 21. The user device of any of clauses 12 to 20, wherein the authentication procedure is a mutual authentication procedure based on exchange of encrypted authentication information.

Clause 22. The user device of any of clauses 12 to 21, wherein the device-to-device communication is based on: BLUETOOTH® low energy (BLE) technology, ultra-wideband (UWB) technology, wireless local area network (WLAN) technology, or sidelink communication technology.

Clause 23. A user device, comprising: means for establishing a device-to-device communication with a point of interaction (POI) device based on a distance between the user device and the POI device being within a reference distance; means for engaging in an authentication procedure with the POI device via the device-to-device communication to verify authenticity of the POI device; means for sending transaction data to the POI device via the device-to-device communication after the authenticity of the POI device is verified; and means for terminating the device-to-device communication after the transaction data is sent to the POI device.

Clause 24. The method of clause 23, further comprising: means for sending a location of the user device to the POI device via the device-to-device communication.

Clause 25. The user device of any of clauses 23 to 24, further comprising: means for receiving receipt data corresponding to processing of the transaction data from the POI device via the device-to-device communication.

Clause 26. The user device of any of clauses 23 to 25, further comprising: means for detecting, based on a first monitoring interval, whether the user device enters a proximity area defined based on a location of the POI device; and means for detecting, after detection of the user device entering the proximity area and based on a second monitoring interval, whether the distance between the user device and the POI device is within the reference distance, wherein the second monitoring interval is equal to or less than the first monitoring interval.

Clause 27. The user device of clause 26, further comprising: means for obtaining a location of the user device; and means for configuring the proximity area based on an identifier of the POI device in association with the location of the user device.

Clause 28. The user device of any of clauses 26 to 27, wherein: the proximity area corresponds to within a five-meter radius from the POI device, and the reference distance corresponds to one meter.

Clause 29. The user device of any of clauses 23 to 28, further comprising: means for receiving a transaction acknowledgement indication from the POI device via the device-to-device communication, wherein the transaction data to the POI device is sent after the transaction acknowledgement indication is received.

Clause 30. The user device of clause 29, further comprising: means for sending user data to the POI device via the device-to-device communication after the authenticity of the POI device is verified, wherein the transaction acknowledgement indication is based on the user data.

Clause 31. The user device of any of clauses 23 to 28, further comprising: means for sending user data to the POI device via the device-to-device communication after the authenticity of the POI device is verified.

Clause 32. The user device of any of clauses 23 to 31, wherein the authentication procedure is a mutual authentication procedure based on exchange of encrypted authentication information.

Clause 33. The user device of any of clauses 23 to 32, wherein the device-to-device communication is based on: BLUETOOTH® low energy (BLE) technology, ultra-wideband (UWB) technology, wireless local area network (WLAN) technology, or sidelink communication technology.

Clause 34. A non-transitory computer-readable medium storing computer-executable instructions that, when executed by a user device, cause the user device to: establish a device-to-device communication with a point of interaction (POI) device based on a distance between the user device and the POI device being within a reference distance; engage in an authentication procedure with the POI device via the device-to-device communication to verify authenticity of the POI device; send transaction data to the POI device via the device-to-device communication after the authenticity of the POI device is verified; and terminate the device-to-device communication after the transaction data is sent to the POI device.

Clause 35. The method of clause 34, further comprising: computer-executable instructions that, when executed by the user device, cause the user device to: send a location of the user device to the POI device via the device-to-device communication.

Clause 36. The non-transitory computer-readable medium of any of clauses 34 to 35, further comprising computer-executable instructions that, when executed by the user device, cause the user device to: receive receipt data corresponding to processing of the transaction data from the POI device via the device-to-device communication.

Clause 37. The non-transitory computer-readable medium of any of clauses 34 to 36, further comprising computer-executable instructions that, when executed by the user device, cause the user device to: detect, based on a first monitoring interval, whether the user device enters a proximity area defined based on a location of the POI device; and detect, after detection of the user device entering the proximity area and based on a second monitoring interval, whether the distance between the user device and the POI device is within the reference distance, wherein the second monitoring interval is equal to or less than the first monitoring interval.

Clause 38. The non-transitory computer-readable medium of clause 37, further comprising computer-executable instructions that, when executed by the user device, cause the user device to: obtain a location of the user device; and configure the proximity area based on an identifier of the POI device in association with the location of the user device.

Clause 39. The non-transitory computer-readable medium of any of clauses 37 to 38, wherein: the proximity area corresponds to within a five-meter radius from the POI device, and the reference distance corresponds to one meter.

Clause 40. The non-transitory computer-readable medium of any of clauses 34 to 39, further comprising computer-executable instructions that, when executed by the user device, cause the user device to: receive a transaction acknowledgement indication from the POI device via the device-to-device communication, wherein the transaction data to the POI device is sent after the transaction acknowledgement indication is received.

Clause 41. The non-transitory computer-readable medium of clause 40, further comprising computer-executable instructions that, when executed by the user device, cause the user device to: send user data to the POI device via the device-to-device communication after the authenticity of the POI device is verified, wherein the transaction acknowledgement indication is based on the user data.

Clause 42. The non-transitory computer-readable medium of any of clauses 34 to 39, further comprising computer-executable instructions that, when executed by the user device, cause the user device to: send user data to the POI device via the device-to-device communication after the authenticity of the POI device is verified.

Clause 43. The non-transitory computer-readable medium of any of clauses 34 to 42, wherein the authentication procedure is a mutual authentication procedure based on exchange of encrypted authentication information.

Clause 44. The non-transitory computer-readable medium of any of clauses 34 to 43, wherein the device-to-device communication is based on: BLUETOOTH® low energy (BLE) technology, ultra-wideband (UWB) technology, wireless local area network (WLAN) technology, or sidelink communication technology.

Clause 45. The user device of any of clauses 1 to 44 is a mobile device, a user equipment (UE), or a processing device onboard a vehicle.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a user device, the method comprising:
establishing a device-to-device communication with a point of interaction (POI) device based on a distance between the user device and the POI device being within a reference distance;
engaging in an authentication procedure with the POI device via the device-to-device communication to verify authenticity of the POI device;
sending transaction data to the POI device via the device-to-device communication after the authenticity of the POI device is verified; and
terminating the device-to-device communication after the transaction data is sent to the POI device.

2. The method of claim 1, further comprising:
sending a location of the user device to the POI device via the device-to-device communication.

3. The method of claim 1, further comprising:
receiving receipt data corresponding to processing of the transaction data from the POI device via the device-to-device communication.

4. The method of claim 1, further comprising:
detecting, based on a first monitoring interval, whether the user device enters a proximity area defined based on a location of the POI device; and
detecting, after detection of the user device entering the proximity area and based on a second monitoring interval, whether the distance between the user device and the POI device is within the reference distance,
wherein the second monitoring interval is equal to or less than the first monitoring interval.

5. The method of claim 1, further comprising:
receiving a transaction acknowledgement indication from the POI device via the device-to-device communication,
wherein the sending the transaction data to the POI device is performed after the transaction acknowledgement indication is received.

6. The method of claim 1, further comprising:
sending user data to the POI device via the device-to-device communication after the authenticity of the POI device is verified.

7. The method of claim 1, wherein the device-to-device communication is based on:
BLUETOOTH® low energy (BLE) technology,
ultra-wideband (UWB) technology,
wireless local area network (WLAN) technology, or
sidelink communication technology.

8. A user device, comprising:
one or more memories;
one or more transceivers; and
one or more processors communicatively coupled to the one or more memories and the one or more transceivers, the one or more processors, either alone or in combination, configured to:
establish a device-to-device communication with a point of interaction (POI) device based on a distance between the user device and the POI device being within a reference distance;
engage in an authentication procedure with the POI device via the device-to-device communication to verify authenticity of the POI device;
send, via the one or more transceivers, transaction data to the POI device via the device-to-device communication after the authenticity of the POI device is verified; and
terminate the device-to-device communication after the transaction data is sent to the POI device.

9. The user device of claim 8, wherein the one or more processors, either alone or in combination, are further configured to:
send a location of the user device to the POI device via the device-to-device communication.

10. The user device of claim 8, wherein the one or more processors, either alone or in combination, are further configured to:
receive, via the one or more transceivers, receipt data corresponding to processing of the transaction data from the POI device via the device-to-device communication.

11. The user device of claim 8, wherein the one or more processors, either alone or in combination, are further configured to:
detect, based on a first monitoring interval, whether the user device enters a proximity area defined based on a location of the POI device; and
detect, after detection of the user device entering the proximity area and based on a second monitoring interval, whether the distance between the user device and the POI device is within the reference distance,
wherein the second monitoring interval is equal to or less than the first monitoring interval.

12. The user device of claim 11, wherein the one or more processors, either alone or in combination, are further configured to:
obtain a location of the user device; and
configure the proximity area based on an identifier of the POI device in association with the location of the user device.

13. The user device of claim 11, wherein:
the proximity area corresponds to within a five-meter radius from the POI device, and
the reference distance corresponds to one meter.

14. The user device of claim 8, wherein the one or more processors, either alone or in combination, are further configured to:
receive, via the one or more transceivers, a transaction acknowledgement indication from the POI device via the device-to-device communication,
wherein the transaction data to the POI device is sent after the transaction acknowledgement indication is received.

15. The user device of claim 14, wherein the one or more processors, either alone or in combination, are further configured to:
send, via the one or more transceivers, user data to the POI device via the device-to-device communication after the authenticity of the POI device is verified,
wherein the transaction acknowledgement indication is based on the user data.

16. The user device of claim 8, wherein the one or more processors, either alone or in combination, are further configured to:
send, via the one or more transceivers, user data to the POI device via the device-to-device communication after the authenticity of the POI device is verified.

17. The user device of claim 8, wherein the authentication procedure is a mutual authentication procedure based on exchange of encrypted authentication information.

18. The user device of claim 8, wherein the device-to-device communication is based on:
BLUETOOTH® low energy (BLE) technology,
ultra-wideband (UWB) technology,
wireless local area network (WLAN) technology, or
sidelink communication technology.

19. The user device of claim 8, wherein the user device is a mobile device, a user equipment (UE), or a processing device onboard a vehicle.

20. A non-transitory computer-readable medium storing computer-executable instructions that, when executed by a user device, cause the user device to:
establish a device-to-device communication with a point of interaction (POI) device based on a distance between the user device and the POI device being within a reference distance;
engage in an authentication procedure with the POI device via the device-to-device communication to verify authenticity of the POI device;
send transaction data to the POI device via the device-to-device communication after the authenticity of the POI device is verified; and
terminate the device-to-device communication after the transaction data is sent to the POI device.

21. The non-transitory computer-readable medium of claim 20, further comprising computer-executable instructions that, when executed by the user device, cause the user device to:
detect, based on a first monitoring interval, whether the user device enters a proximity area defined based on a location of the POI device; and
detect, after detection of the user device entering the proximity area and based on a second monitoring interval, whether the distance between the user device and the POI device is within the reference distance,
wherein the second monitoring interval is equal to or less than the first monitoring interval.
